(19) United States
(12) Patent Application Publication
(10) Pub. No.: US 2018/0211202 A1
(43) Pub. Date: Jul. 26, 2018

(54) METHOD, SYSTEM, APPARATUS, AND PROGRAM FOR REAL-TIME AND ONLINE FREIGHT MANAGEMENT

(71) Applicant: Eugenio S. Ynion, JR., San Pedro City (PH)

(72) Inventor: Eugenio S. YNION, JR., San Pedro City (PH)

(21) Appl. No.: 15/879,127

(22) Filed: Jan. 24, 2018

Related U.S. Application Data
(60) Provisional application No. 62/450,836, filed on Jan. 26, 2017.
(60) Provisional application No. 62/472,409, filed on Mar. 16, 2017.
(60) Provisional application No. 62/547,064, filed on Aug. 17, 2017.
(60) Provisional application No. 62/551,122, filed on Aug. 28, 2017.

(51) Int. Cl. G06Q 10/08; G06Q 10/02; G06F 21/62; G06F 21/31

(52) U.S. Cl. CPC G06Q 10/083; G06Q 10/02; G06Q 10/06313; G06F 21/31; G06F 21/6218

(57) ABSTRACT

A method, system, apparatus, and program for real-time and online on-demand shipping/freight management in the global logistics industry using various technologies such as: Global Positioning System (GPS); Satellite feeds; Various cloud-based communication platforms for Simple Message System (SMS), Email, Chat; Blockchain; Own blackbox module; Real-time online payment system; and other related components. A system for processing and storing transactions and reservations for online freight management comprises: an end-user module for interfacing with a user device through an exclusive ingress module to execute a login procedure, wherein a user of the user device is a service provider; a middleware module for processing a request for a transaction by the user; a back-office corporate module for performing a procedure-based integrity check on each transaction, for managing each transaction, and for interfacing with the user device through an exclusive egress module to execute a logout procedure; and a black-box module communicating with the middleware module and using various technologies for monitoring users and storing data including transaction data, user profile data, and communication data, wherein the black-box module, among others, includes an entity relationship database for storing the data in an organized and readily retrievable structure.\

### CROSS-REFERENCE TO RELATED APPLICATION

The present nonprovisional application claims the benefit of U.S. Provisional Applications Nos. 62/450,836 filed on Jan. 26, 2017, 62/472,409 filed on Mar. 16, 2017, 62/547,064 filed on Aug. 17, 2017, and 62/551,122 filed on Aug. 28, 2017, and incorporates each of the same by reference herein.

### BACKGROUND OF THE INVENTION

### Field of the Invention

The present invention generally relates to a method, system, apparatus, and program for real-time and online freight management, and more particularly to an improved method, system, apparatus, and program for real-time and online freight management in the global logistics industry using a real-time chained black box.

### Related Art

One problem with the current global situation in the shipping, logistics and freight forwarding industries is that they are operating based on old and fragmented manual and automated systems which vary per country. This entails a large amount of paperwork, phone calls, and back and forth communication among the parties involved. It also often requires several layers of intermediaries (persons, corporations, etc.), and this creates additional layers of cost and process delay in the importing and exporting of physical goods across the globe. Furthermore, the records from various stakeholders are prone to integrity and accuracy constraints.

At present, there is no integrated and central storage of the various transactions involving the various stakeholders in the import and export of goods. More particularly, there is no integrated solution which can operate in a real-time and online mode using the Internet and Electronic Data Interchange (EDI) standards. An improved approach is therefore needed.

### SUMMARY OF THE INVENTION

The foregoing and other problems are overcome by a new method for real-time and online freight management, and also by a system, apparatus, and program that operate in accordance with the method.

The present invention in one aspect provides integrated and central storage of the various transactions involving the various stakeholders in the import and export of goods. The invention can provide a central, real-time recording and fully immutable repository of all concerned transactions created by both human and automated systems, which does not exist today, especially in the global logistics and shipping industry. The present invention provides an integrated solution which can operate in a real-time and online mode using the Internet and Electronic Data Interchange (EDI) standards. In one aspect the invention is a real-time chained black-box.

The solution of the present invention is the creation of computer software in conjunction with customized processes and techniques which can allow for a fully automated and online manner of completing a shipping transaction or freight forwarding transaction (i.e., import or export) “anywhere and anytime” across the globe, directly connecting a shipper (the importer or exporter) to all its service providers. The “service providers” may include: a. trucking company, b. warehouse operators, c. shipping company, d. customs brokers and financial institutions for online payment of transactions.

The solution of the present invention involves the creation of a computer software leveraging on various technologies—including “blockchain.” The use of “blockchain” technology, not exclusively but in conjunction with other forms of technologies, in the creation of the “black-box” of the present invention is the first one in the industry and is a novel and unique way of recording transactions in an immutable mechanism.

A blockchain (database) is a continuously growing list of records or “blocks” which are linked and secured using cryptography. Each block typically contains a hash pointer as a link to a previous block, a timestamp, and transaction data. By design, blockchains are inherently resistant to modification of the data. Functionally, a blockchain can serve as an open, distributed ledger that can record transactions between two parties efficiently and in a verifiable and permanent way. For use as a distributed ledger a blockchain is typically managed by a peer-to-peer network collectively adhering to a protocol for validating new blocks. Once recorded, the data in any given block cannot be altered retroactively without the alteration of all subsequent blocks and a collusion of the network majority. Blockchains are secure by design and are an example of a distributed computing system with high Byzantine fault tolerance. Decentralized consensus has therefore been achieved with a blockchain. This makes blockchains suitable for records management activities, such as identity management, transaction processing, and documenting provenance.

The concept of “black-box” may be said to be common in the airline industry wherein a plane in flight will record almost all recordable events in the plane while in flight. However, the same concept has never been implemented in the software industry and in particular to shipping and logistics, and it is not easy to implement the concept in these industries. The “black-box” in the airline industry is a closed system which is only used by authorities in the airline industry. In contrast, the black-box of the present invention is open to both registered end users and/or to customers of the invention software and can also be open to private and government authorities to view the transaction history of any global shipment arranged through the platform of the present invention.

In the software industry the black-box concept is not used but there are various logs or recordings done at random. However, in the present invention, all recordable events are digitally recorded into a database and/or flat-file and subsequently into a blockchain-enabled system to ensure immutability of records and increased data integrity.

Some of the more notable preferred aspects or features of the invention include the following. First, the computer software can use any computer or mobile device that can run browser software (e.g., Chrome, Edge, Firefox, Safari, Explorer, etc.) over the Internet. Second, the computer software can also use any device which runs operating systems such as Windows, Android and Apple iOS operating systems with access to the Internet. Third, the computer software exchanges digital data and metadata with other computer software running on a private or public cloud in order to establish online and 24/7 interaction. Fourth, the computer software supports its various stakeholders for their respective management and staff to easily operate the computer software through customized processes and techniques.

The present invention can be implemented using hardware, software, or a combination of both, including using where suitable one or more computer programs, mobile applications or “apps” (such as in devices 108, 110, 112, 114, etc. shown in the drawings and described more fully below). As is well known in the art, an app is a software application designed to run on mobile devices such as smartphones. Mobile apps are available through application distribution platforms, which are typically operated by the owner of the mobile operating system. Usually, mobile apps are downloaded from the platform to a target device such as a smartphone. Mobile apps are also sometimes downloaded to less mobile computers, e.g., laptops or desktops.

A “smartphone” as used herein includes the class of mobile phones or devices built on a mobile operating system, with more advanced computing capability and connectivity than a feature phone. Smartphones typically include high-resolution touch screens and web browsers that display standard web pages, as well as mobile-optimized sites. High-speed data access is provided by, e.g., Wi-Fi or Mobile Broadband. Common mobile operating systems in use include but are not limited to Apple's iOS, Nokia's Symbian, RIM's BlackBerry OS, Google's Android, Samsung's Bada, Microsoft's Windows Phone, and Hewlett-Packard's webOS. Such operating systems can be installed on many different phone models.

The present invention according to an example aspect provides a system for processing and storing transactions and reservations for online freight management, comprising: an end-user module for interfacing with a user device through an exclusive ingress module to execute a login procedure, wherein a user of the user device may be, e.g., a service provider; a middleware module for processing a request for a transaction by the user; a back-office corporate module for performing a procedure-based integrity check on each transaction, for managing each transaction, and for interfacing with the user device through an exclusive egress module to execute a logout procedure; and a black-box module communicating with the middleware module and storing data including transaction data, user profile data, and communication data, wherein the black-box module includes an entity relationship database for storing the data in an organized and readily retrievable structure.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will be more readily understood from a detailed description of the exemplary embodiments taken in conjunction with the following figures.

FIG. 1 is a block diagram 100 of a system of the present invention according to one example embodiment.

FIG. 2 shows another block diagram of the system 100 of the present invention according to an example embodiment.

FIG. 3 also shows another block diagram of the system 100 of the present invention according to an example embodiment.

FIG. 4 is a flowchart showing a method that can operate in accordance with the system(s) shown in FIGS. 1-3.

FIGS. 5A-T show the database design in an Entity Relationship Diagram (ERD), according to an example embodiment of the present invention.

FIG. 6 is an AWS computer server infrastructure schematic showing the overall hardware and software setup of the system 100 according to one example embodiment.

FIG. 7 shows the system 100 of the present invention according to an example embodiment in which transactions occurring inside the system are saved to the black-box module 105.

FIG. 8 shows a close-up view of the integration infrastructure of the middleware module 104 of FIGS. 1-3 according to an example embodiment of the present invention.

FIG. 9 shows the back-office module 106 of FIGS. 1-3 according to an example embodiment of the present invention.

FIG. 10 shows a detailed view of the exclusive ingress module 101 shown in FIGS. 2 and 3 and its processes according to an example embodiment of the present invention.

FIG. 11 shows a sample screenshot illustrating the home screen for a shipper or exporter/importer, as an example.

FIG. 12 shows a detailed view of the exclusive egress module 103 of FIG. 2 and FIG. 3 and its processes according to an example embodiment of the present invention.

FIG. 13 shows an example of a sub-module 102-A within the end-user module 102 of FIGS. 1-3, interacting with a customs broker in particular.

FIG. 14 shows an example of a sub-module 102-B within the end-user module 102 of FIGS. 1-3, interacting with a shipping company in particular.

FIG. 15 shows an example of a sub-module 102-C within the end-user module 102 of FIGS. 1-3, interacting with a warehouse operator in particular.

FIGS. 16A-V show the database design in an Entity Relationship Diagram (ERD), according to another example embodiment of the present invention.

FIG. 17 is a flowchart illustrating a process and technique of implementing a bidding process (rate) selection by the shipper given the various rates available from the different shipping carriers, according to an example embodiment of the present invention.

The invention will next be described in connection with certain exemplary embodiments; however, it should be clear to those skilled in the art that various modifications, additions, and subtractions can be made without departing from the spirit or scope of the claims.

### DETAILED DESCRIPTION OF THE PREFERRED EMBODIMENTS

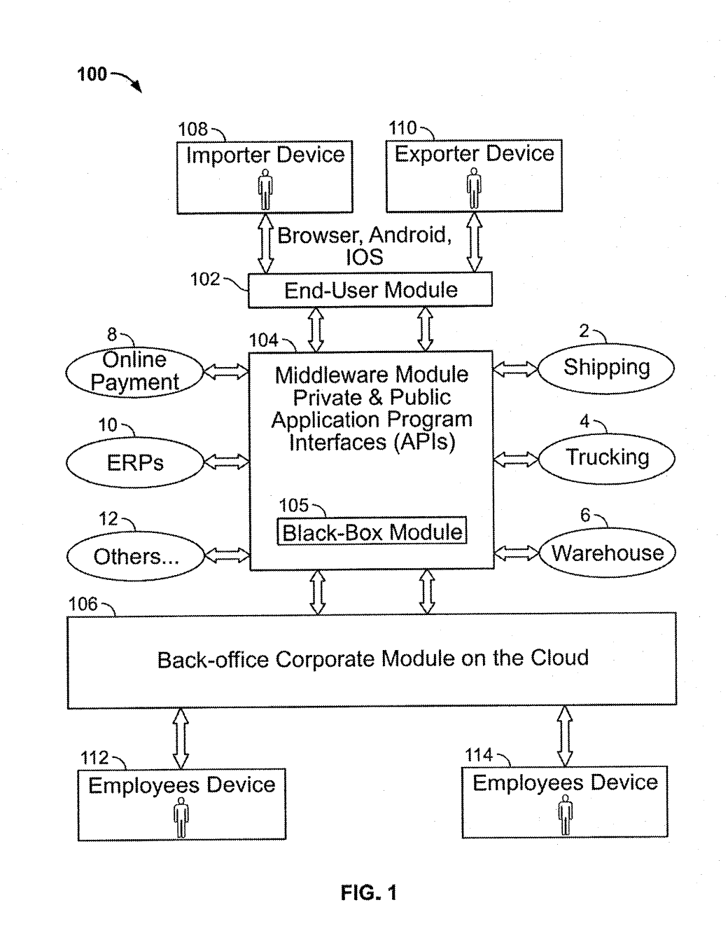

FIG. 1 is a block diagram of a system 100 of the present invention according to an example embodiment. One component of the system 100 is an end-user module 102, which is a component of the computer software that can interact with customers, e.g., importers and exporters, and all other stakeholders in the process via devices such as importer and exporter devices 108, 110 (or others). A second component is a middleware module 104. The middleware module 104 is the component of the computer software that talks to other computer software components being used by the other stakeholders in the import and export process. The middleware module 104 includes private and public Application Program Interfaces (APIs) that relate to shipping 2, trucking 4, warehouse 6, online payment 8, ERPs 10 (Enterprise Resource Planning), and other entities 12. A third component is a back-office corporate module 106, which may preferably be on the cloud (but need not be) and is the component of the computer software that is used by the employees and support or admin people of the corporation or entity that operates the computer software, who interact with the back-office corporate module via devices such as employee devices 112, 114 (or others). The back-office corporate module 106 is responsible for ensuring the integrity of all transactions.

With respect to implementing the middleware module 104 with a web service for third party applications integration infrastructure, a middleware in the software is similar to a bridge; it bridges external systems into the software through the use of a web service or application program interface (API). This bridging of systems through the middleware establishes a two-way communication channel among systems interacting with the software.

Another notable component of the invention is a black-box module 105, which is shown in FIG. 1 as a component of the middleware module 104 of the software platform, but of course the black-box module 105 could be a separate module interacting with the middleware module 104 and others. Anyone who is inside or using the system 100 is monitored by the black-box module 105. This means that all important digital transactions, user profile changes, and communication with other stakeholders can be performed inside the system 100. Online payments and related important actions can be permanently and immutably recorded inside by the black-box module 105.

The black-box module 105 is a combination of computer software, interne, database, blockchain, and related technologies. Notably, in one example embodiment of the invention, the black-box module 105 cannot be bypassed even if an unauthorized person or entity attempts to gain entry to the platform. The black-box module 105 has various levels of software triggers which allow for automatic recording at various levels in the overall hardware and software platform. The only allowed access to the black-box module 105 is for reporting and viewing of transactions inside the black-box module. No update, edit, or delete is possible for data recorded inside the black-box module 105.

The black-box module continuously records all pertinent or relevant transactions in the system of the present invention (XLOG). This recording of data ensures the integrity of all transactions in the database since all transactions can be reviewed or audited anytime. A virtually unlimited number of transactions can be recorded in the system. The black-box module can be fully integrated into the system.

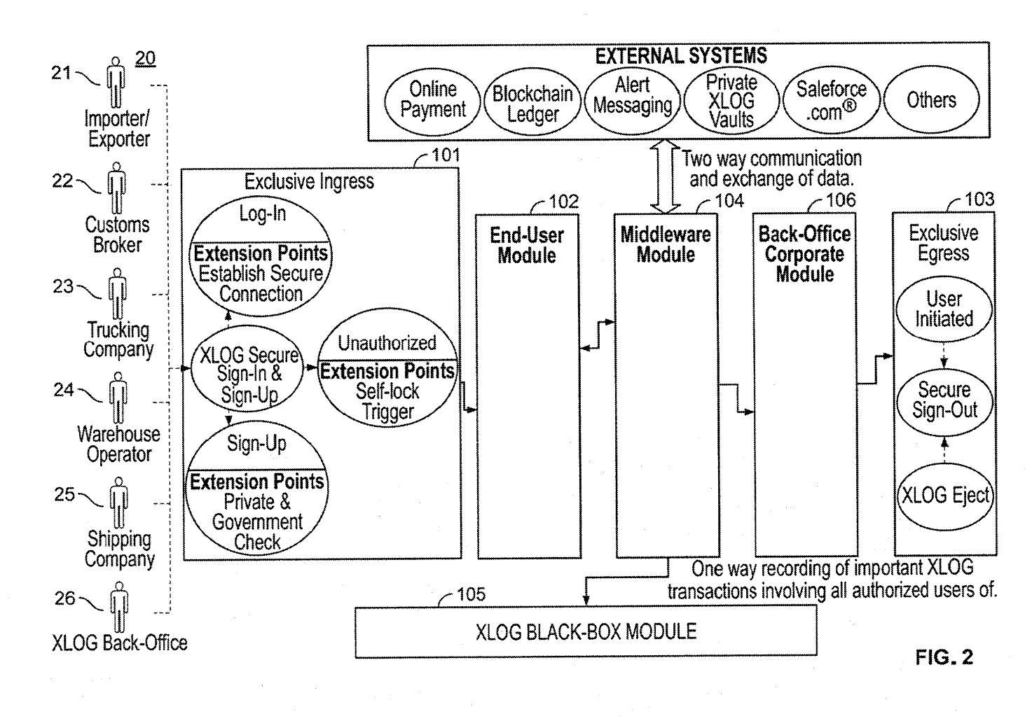

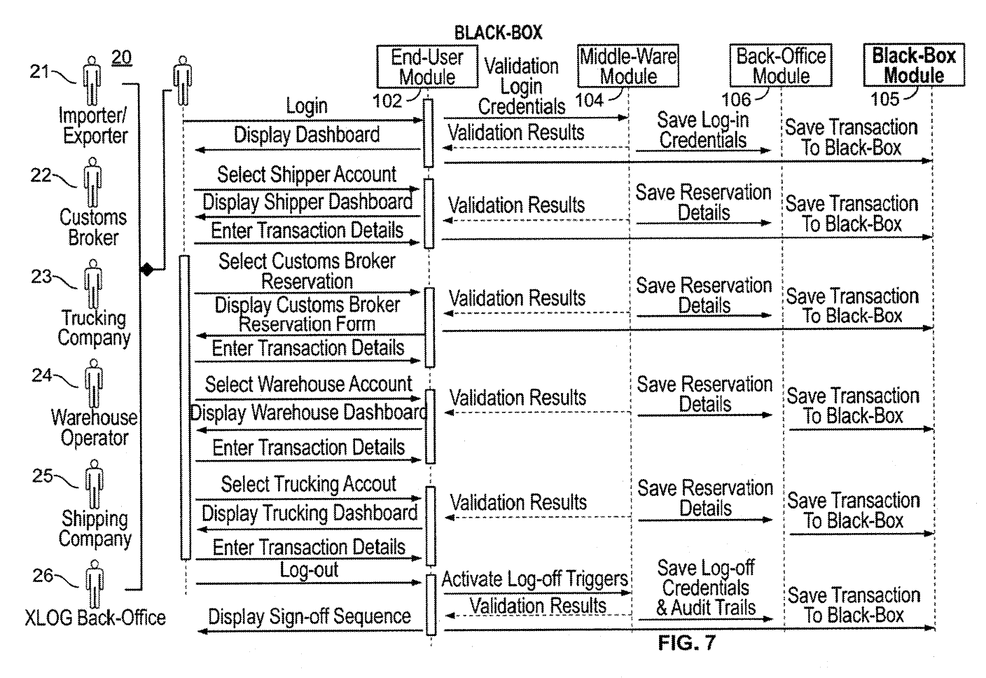

FIG. 7 shows the system 100 according to an example embodiment of the present invention illustrating how the black-box module 105 of FIG. 2 interfaces with the other modules and components of the system, particularly the end-user module 102, the middleware module 104, the back-office corporate module 106, and the various participants 20 who are participating via their devices 108, 110, 112, 114, such as importer/exporter 21, customs broker 22, trucking company 23, warehouse operator 24, shipping company 25, back-office participant 26, or others (not shown). It is of course to be understood that the participants 20 are just examples, and other parties representing other industries/etc. could be participants as well.

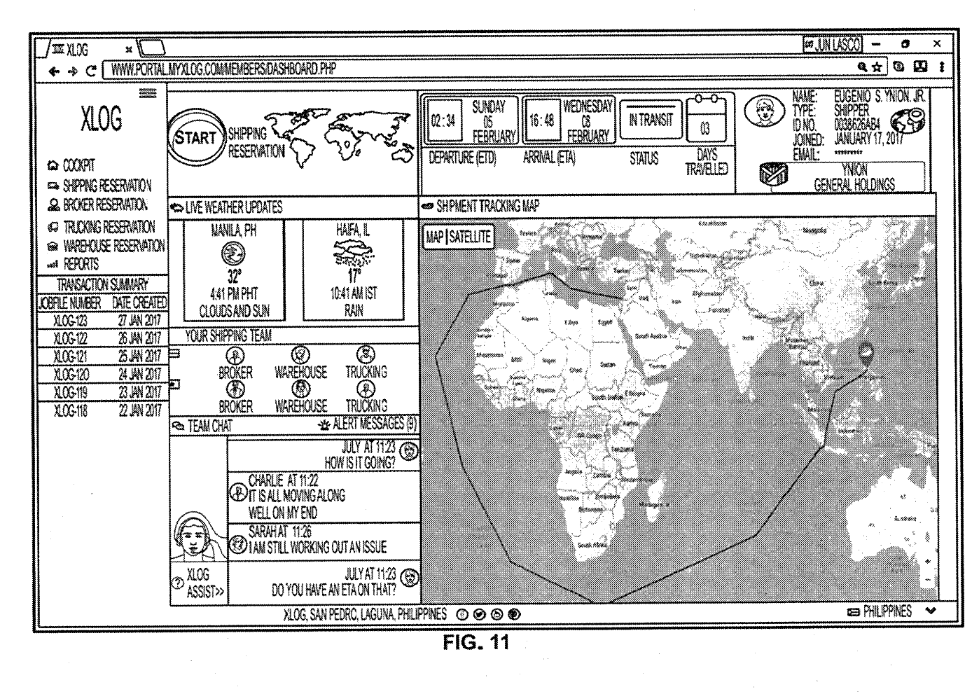

FIG. 7 shows a procedure or method of the system 100 according to an example embodiment in which transactions occurring inside the system are saved to the black-box module 105. First, the end-user module 102 carries out a login procedure after accepting a login request from one of the participants 20, e.g., an importer/exporter 21, customs broker 22, trucking company 23, warehouse operator 24, shipping company 25, back-office participant 26, or others. The back office participant 26 can have access to End-User Module 102 and Back-Office Module 106. If the end-user module 102 determines that the participant 20 requesting login has valid login credentials, a dashboard is displayed such as that shown in FIG. 11, discussed further below.

Once granted login the participant or user 20 can carry out various authorized tasks. For example, an importer/exporter 21 is enabled to carry out tasks such as selecting a shipper account, and see a shipper dashboard, and enter transaction details. A customs broker 22 is enabled to carry out tasks including selecting a customer broker reservation, and see a customer broker reservation form, and enter transaction details. A user for a trucking company 23 is enabled to carry out tasks including selecting a trucking account, see a trucking dashboard, and entering transaction details. A warehouse operator 24 is enabled to carry out tasks including selecting a warehouse account, see a warehouse dashboard, and enter transaction details. Once the user or participant 20 requests logout, a logoff procedure is activated by the middleware module 104 and a sign-off sequence is carried out by the end-user module 102.

As can be seen in FIG. 7, all items such as login credentials, reservation details, transaction details, audit trails, and logoff credentials are saved by the back-office module 106 to the black box module 105.

Accordingly, it can be seen from the description and drawings herein that the black-box module 105 is the component of the system 100 that stores all digital/electronic transactions which occur inside the system 100. All transactions of the major stakeholders and other participants or users can be stored or saved within the system's black-box module 105.

FIG. 2 shows a more detailed block diagram of the system 100 of the present invention according to an example embodiment. It is noted that the end-user module 102 is designed to be the only and main interaction component of the system 100. The end-user module 102 is not allowed to interact with any external software systems except the exclusive ingress module 101 (internal sign-in module). The end-user module 102 handles functional processes including for example, but not limited to, the following:
1. Shipping Reservation
2. Truck Reservation
3. Warehouse Reservation
4. Customs Broker Reservation
5. Employee Collaboration & Support
6. Other Authorized Users.

The middleware software module 104 comprises various micro-services or groups of independent computer programs which can act independently in collaboration with other micro-services. The middleware module 104 is also the module which interacts with third-party or external computer systems. Internally, the middleware module 104 is the central processor of all requests for transactions by the various actors or users of the system. A critical attribute of the middleware module 104 is that it is able to concurrently and instantly complete an online transaction by a system user in collaboration with other systems.

As noted above, the back-office corporate software module 106 is responsible for ensuring the integrity of all transactions. This involves a combination of automated verifications and procedure-based integrity checks through the use of back-office support staff of the company running the platform. The back-office module 106 is not allowed to interact with any other computer systems except the internal middleware module 104. The only interaction is with the exclusive egress module 103 (sign-out module) which is designed to automatically or manually log off or exit an online user.

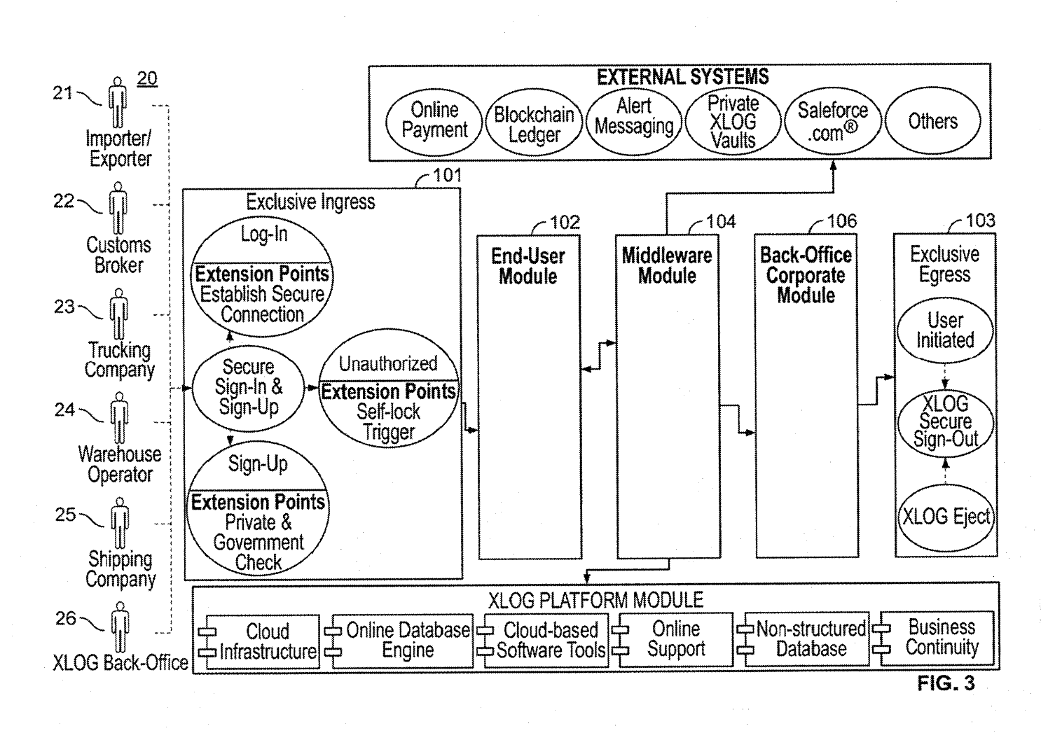

FIG. 3 shows a more detailed block diagram of the system 100 of the present invention as well, according to an example embodiment. The platform of FIG. 3 coming off the middleware module 104 includes blocks comprising Cloud Infrastructure, Online Database Engine, Cloud-based Software Tools, Online Support, Non-structured Database, and Business Continuity, which need not be specific to the middleware module 104 but may comprise the overall or total platform of XLOG to operate.

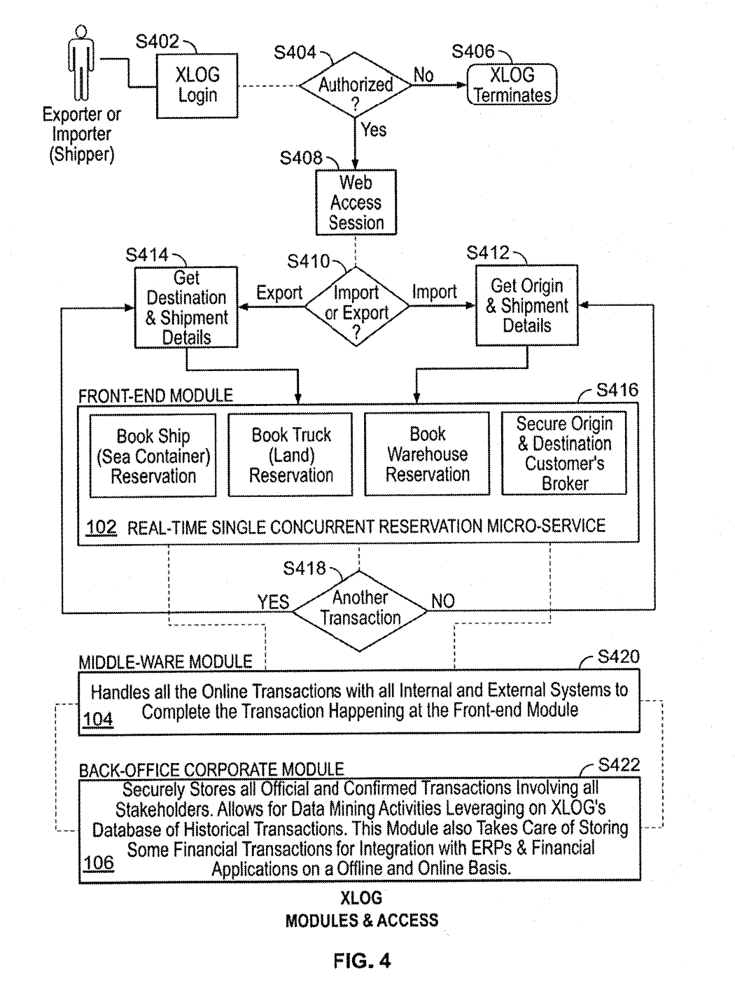

FIG. 4 is a flowchart showing a method 400 that can operate in accordance with the system 100 shown in FIGS. 1-3.

In the example method 400 shown in FIG. 4, the processes carried out by the front-end module, i.e., the end-user module 102 operating in conjunction with the exclusive ingress module 101, are as follows. In step 5402 the end-user module 102 enables an exporter or importer (shipper) to login using his or her device 108, 110. The device 108, 110 may be a computer system such as a personal computer (PC), laptop, etc., or a handheld device or smartphone having a mobile app or computer program installed therein. In step S404 the end-user module 102 checks with the middleware module 104 whether the exporter or importer attempting to log in is authorized to do so. If not then in step S406 the process is terminated. If so then the method performed by the end-user module 102 proceeds to a Web Access Session in step S408, and a web access session is begun. If it is determined by the end-user module 102 in step S410 that the work is importing then the method performed by the end-user module 102 proceeds in step S412 to obtain the origin and shipment details. If on the other hand it is determined by the end-user module 102 in step S410 that the work is exporting then the method proceeds in step S414 to obtain the destination and shipment details.

In step S416 functions can be carried out as applicable such as book ship (sea carrier) reservation, book truck (land) reservation, book warehouse reservation, secure origin and destination customers broker, etc. These are performed by the front-end or end-user module 102 employing real-time single concurrent reservation micro-service. In step 5418 it is determined whether another transaction is desired and if so the process goes back to step S410 and if not the process goes back to step S408.

In the meantime the middleware module 104 performs step 5420 in handling all the online transactions with all internal and external systems to complete the transaction(s) happening at the end-user module 102. The back-end office corporate module 106 securely stores all official and confirmed transactions involving all stakeholders, allows for data mining activities leveraging on a database of historical transactions, and also stores financial transactions for integration with ERPs and financial applications on an offline/online basis.

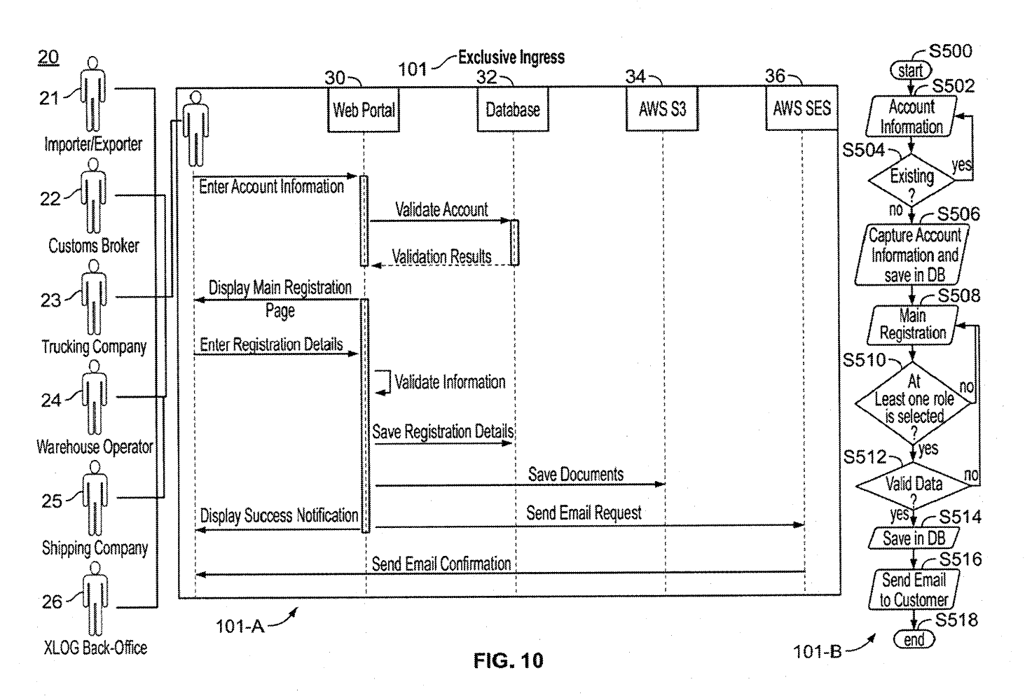

FIG. 10 shows a detailed view of the exclusive ingress module 101 shown in FIG. 2 and FIG. 3 and its processes according to an example embodiment of the present invention. Here it is noted that a conventional ingress/egress module is done by using a user-identification and typing the password; however, the present invention goes beyond such conventional method in at least one respect, by combining biometrics and a one-time password or session key by sending a user 20 of the system 100 a password or key via the mobile phone through an SMS (Simple Message System) or text message.

As shown in FIG. 10 the exclusive ingress module 101 has a login procedure for establishing a secure connection between a user 20 and the end-user module 102 and for signing in and signing up a user 20 when authorized. Element 101-A of FIG. 10 shows a web portal 30, a database 32, Amazon Web Services (AWS) S3 34, and AWS SES 36. (S3 refers to Simple Storage Service and SES refers to Simple Email Service.) Thus, the exclusive ingress module 101 may be implemented through the facility of Amazon Web Services (AWS) for third party applications, for example. The Application Program Interface (API) setup under AWS allows for a highly efficient and secure method for online/real-time integration with various systems outside of the system 100 of the present invention. A user of the system 100 does not have to worry about how the system 100 integrates with various systems that are not originally a part thereof. The API component handles this integration requirement.

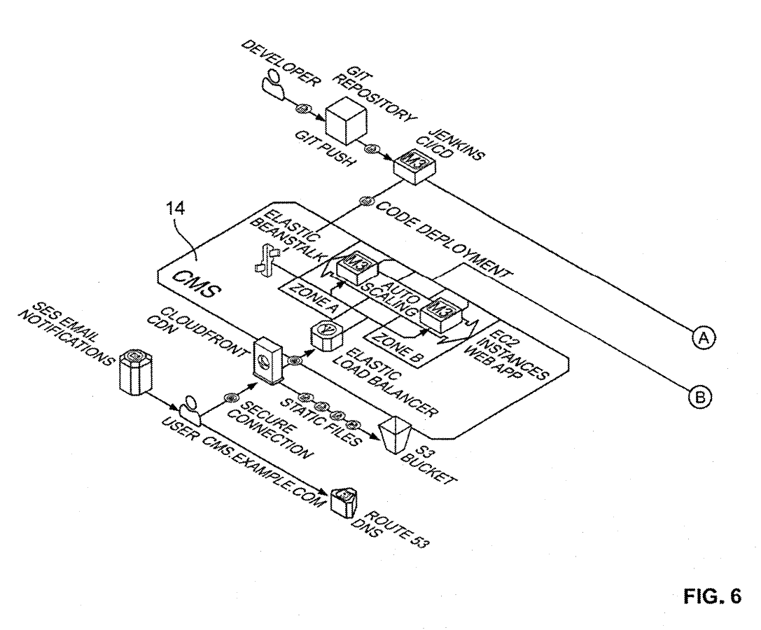

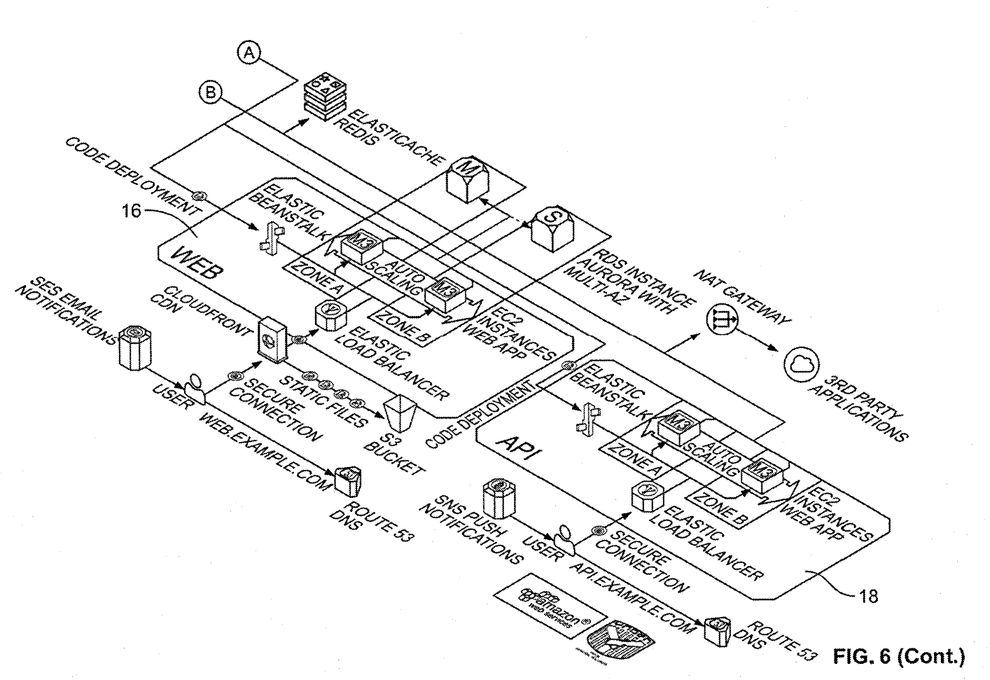

Thus, the AWS is the Amazon Web Services setup of the system 100 of the present invention. See the AWS computer server infrastructure schematic shown in FIG. 6. This is the overall hardware and software setup of the system 100 according to one example embodiment. FIG. 6 shows how the various components, hardware and software including the Content Management System (CMS) 14, web component 16, and Application Program Interface (API) 18 work together as one integrated solution.

That is, the system 100 of the present invention (XLOG) is designed to include three (3) major components. The first is the Content Management System (CMS) 14. Another is the web component 16. Another is the Application Program Interface (API) 18. The API 18 was created to handle all of the external system integration requirements which would allow the system 100 to interface with other, outside systems. API is RESTful Web services to provide interoperability between other systems, using OAuth 2 as industry standard protocol for authorization, which provides simplicity in authorization flows for web, desktop, and mobile applications. The CMS 14 is like the back-office and administration component of the system 100. In other words, CMS is a backend content management system, which provides an intuitive user interface for modifying web page content. This is where applications and transactions from the web interface is reviewed and approved.

The WEB component 16 is the main user interface for the various stakeholders of XLOG. WEB is a frontend web interface where shipper, broker, trucker and warehouse carry out their transactions.

For the backend, Linux can be the operating system; Apache can be the web server; MySQL can be the database; and PHP can be the programming language.

For the frontend, Vue.js can be the JavaScript framework; Bulma can be CSS framework; and SASS can be the CSS Pre-processor.

“Auto scaling” is a method used in cloud computing, whereby the amount of computational resources in a server farm, typically measured in terms of the number of active servers, scales automatically based on the load on the farm. Auto Scaling helps the operator have the correct number of Amazon EC2 instances available to handle the load for your application. Zones A&B take advantage of the safety and reliability of geographic redundancy by spanning the Auto Scaling group across multiple Availability Zones within a region.

“Elastic Beanstalk” as used in FIG. 6 is an AWS tool that enables to quickly deploy and manage applications in the AWS Cloud without worrying about the infrastructure that runs those applications. The Elastic Beanstalk reduces management complexity without restricting choice or control. When an application is uploaded, the Elastic Beanstalk can automatically handle the details of capacity provisioning, load balancing, scaling, and application health monitoring. The system can be configured to deploy its application and environments by the Elastic Beanstalk, which automatically handles the details of capacity provisioning, load balancing, auto scaling and application health monitoring.

Simple Storage Service (S3) allows users to store and retrieve various sized data objects using simple API calls. S3 is designed for 99.999999999% durability and 99.99% availability. S3 does not comprise a computing element and is only a storage. An independent computing device or tool (such as EC2 ) can be used to compute data. The disclosed system can store all static files in S3 such as product images, pdf manuals, and videos.

Relational Database Service (RDS) is Amazon Relational Database Service (Amazon RDS) that makes it easy to set up, operate, and scale a relational database in the cloud. It provides cost-efficient and resizable capacity while managing time-consuming database administration tasks, freeing an operator up to focus on the applications and business. The XLOG deployment can use Amazon RDS MySQL with Multi-AZ Deployments. With Multi-AZ deployment, Amazon RDS automatically provisions and manages a “standby” replica in a different Availability Zone (independent infrastructure in a physically separate location). In the event of planned database maintenance, DB Instance failure, or an Availability Zone failure, Amazon RDS will automatically failover to the up-to-date standby.

Virtual Private Cloud (VPC) allows an operator to logically isolate a section of the AWS cloud and provision services inside of that isolated network. Using VPC helps provision services inside AWS and it is enabled by default for all new accounts. VPC has various configuration options for accessibility to the Internet and other AWS services. Public-facing subnets can be created in VPC, where the instances can have direct access to the public Internet gateway and other AWS services. Instances can be provisioned in private subnets as well, where their access to the Internet and other AWS services can be restricted or managed through network address translation (NAT). RDS instances can be accessed from within a VPC.

Elastic Compute Cloud (EC2 ) allows users to rent virtual machines of different configurations, on demand, for the time required. For this deployment, EC2 instances are the equivalent of servers that run Jenkins (continuous integration and continuous delivery toolchain). EC2 offers several different types of instances with different pricing options.

Amazon ElastiCache (Redis) automatically detects and replaces failed nodes, reducing the overhead associated with self-managed infrastructures and provides a resilient system that mitigates the risk of overloaded databases, which can slow the website and increase application load times. For XLOG deployment, Redis is used as a session store and application cache.

Amazon Simple Email Service (Amazon SES) is a cost-effective email service built on the reliable and scalable infrastructure that Amazon.com developed to serve its own customer base. With Amazon SES, one can send and receive emails with no required minimum commitments—users only pay for what the users use.

Amazon Route 53 is a highly available and scalable cloud Domain Name System (DNS) web service. All DNS request to XLOG can be handled by AWS Route 53.

Amazon CloudFront is a global content delivery network (CDN) service that accelerates delivery of websites, APIs, video content or other web assets through CDN caching.

Amazon Simple Queue Service (SQS) offers a reliable, secure, and highly-scalable hosted queuing service for storing messages in transit between computers. SQS can be used by XLOG to queue time consuming task like image resize, document processing and sending emails. Deferring these time consuming tasks drastically speeds up web requests to the application.

AWS CodeCommit is a fully-managed source control service that makes it easy for companies to host secure and highly scalable private Git repositories. All XLOG application source code can be securely stored using CodeCommit.

For high availability and security, the present disclosure can have: multi-AZ architecture intended for high availability, isolation of instances between private/public subnets, security groups limiting access to only necessary services, network access control list (ACL) rules to filter traffic into subnets as an additional layer of network security, standard IAM policies with associated groups and roles, exercising least privilege, implementation of proper load balancing and auto scaling capabilities, and Amazon RDS database backup and encryption.

The performance of XLOG application may depend on many factor including EC2 instance type, Provisioned IOPS, and application workload. With cloud computing such as AWS, there are number of principles the present disclosure can achieve in terms of performance and efficiency. First, it is easy to deploy the system in multiple regions around the world with just a few clicks. This allows the operator to provide lower latency and a better experience for the customers at minimal cost. Second, with virtual and automatable resources, comparative testing using different types of instances, storage, or configurations can be quickly carried out. Third, with cloud computing, the operator need not guess capacity needs. He or she can use as much or as little capacity as he or she needs, and scale up and down automatically. Fourth, in the cloud, the capability to automate and test on demand lowers the risk of impact from design changes. This allows the systems to evolve over time so that businesses can take advantage of innovations as a standard practice.

With regard to networking and security, the present disclosure can use VPC and Security Groups. VPC is a logically separated section of the AWS cloud that provides complete control over the networking configuration, including the provisioning of an IP space, subnet size and scope, access control lists, and route tables. Security Groups are analogous to firewalls. Rules for EC2 instances can be defined, and allowable traffic, IP addresses, and port ranges can be defined.

XLOG can be currently run for example on 64bit Amazon Linux 2017.03 v2.4.0 running PHP 7.0 AMI using Elastic Beanstalk. For more efficient development lifecycle, different environments, which can be easily promoted to production, can be set up. First, the development environment is where latest changes can be continuously deployed into the development server or sandbox. This is where testing is performed by the developer. Second, user acceptance testing (UAT) is the stage where interface testing can be performed. The quality assurance team can make sure that the new code will not have any impact on the existing functionality and they can test major functionalities of the system once after deploying the new code in their respective environment. Lastly, in the production stages, the system can serve end-users.

XLOG can be deployed through a cloud service (such as AWS services) to regions that are self-contained geographical locations. The regions can have their own deployment of each service. Each service within a region has its own endpoint that the operator can interact with to use the service. The regions contain availability zones, which are isolated locations within a general geographical location. Some regions can have more availability zones than others. While provisioning, the operator can choose specific availability zones or let AWS select.

The flowchart in FIG. 10 describes an exclusive ingress procedure as carried out by the exclusive ingress module 101 according to an example embodiment. In step S500 the procedure begins. In step 5502 account information entered by the user 20 into the web portal 30 is received. In step S504 it is determined whether the user 20 is an existing user. If the answer to step S504 is Yes, the method returns to step S502, however, please refer to FIG. 2 (101-A) which shows that the next step is for the system to validate/verify the account information in the database for further validation and security check before the user is allowed access inside the system 100. If the answer to step S504 is No, then the web portal displays a main registration page and in step S506 the account information, which is inputted by the user 20, is captured and saved in the database 32. Then in step S508 the main registration protocol is carried out and the main registration page is displayed to the user 20, and the registration details entered by the user 20 are received.

In step S510 it is determined whether at least one role is selected. If not, the procedure returns to the main registration protocol of step S508; if so, the procedure in step S512 determines whether the data (e.g., the registration details entered by the user) is valid. If the data is valid then in step S514 the data is saved in the database 32; if not, the procedure returns to the main registration protocol of step S508. In step S516 the web portal sends an email request to a cloud email provider (here, Amazon Web Services Simple Email Service), and an email is sent to the customer or user 20 and then in step S518 the procedure ends. All documents, emails, and email requests can be saved.

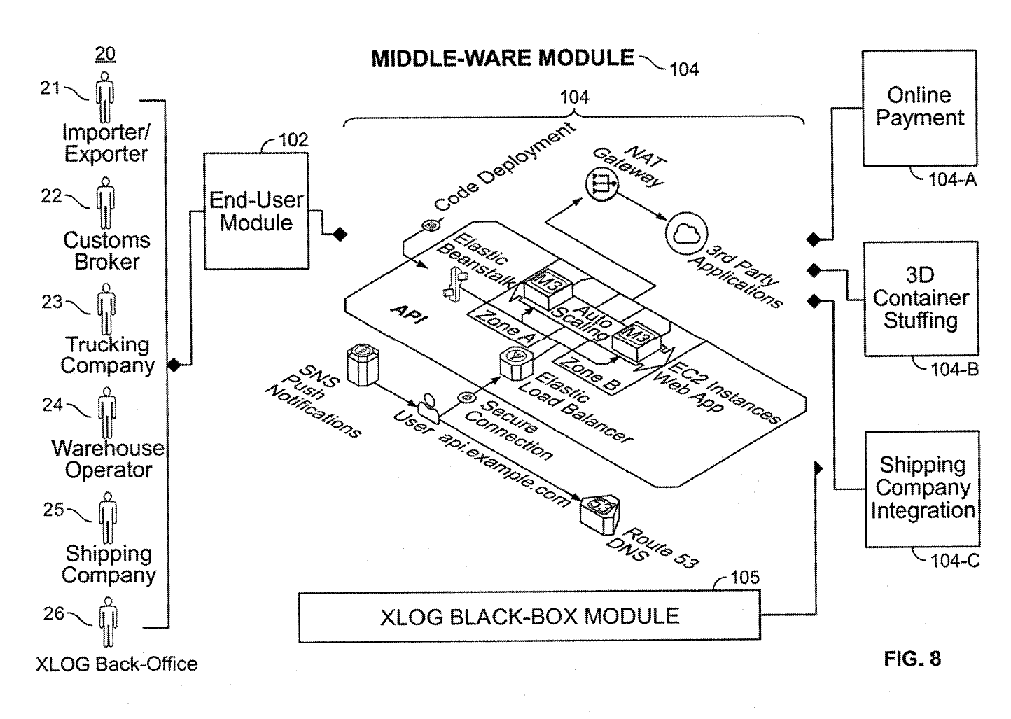

FIG. 8 shows a close-up view of the integration infrastructure of the middleware module 104 of FIGS. 1-3 according to an example embodiment of the present invention. The middleware module 104 may be implemented through the facility of Amazon Web Services (AWS) for third party applications, for example. The Application Program Interface (API) setup under AWS allows for a highly efficient and secure method for online/real-time integration with various systems outside of the system of the present invention (XLOG). A user of the system does not have to worry about how the system integrates with various systems that are not originally a part thereof. The API component handles this integration requirement. Functions such as online payment 104-A, 3D container stuffing 104-B, and shipping company integration 104-C are carried out.

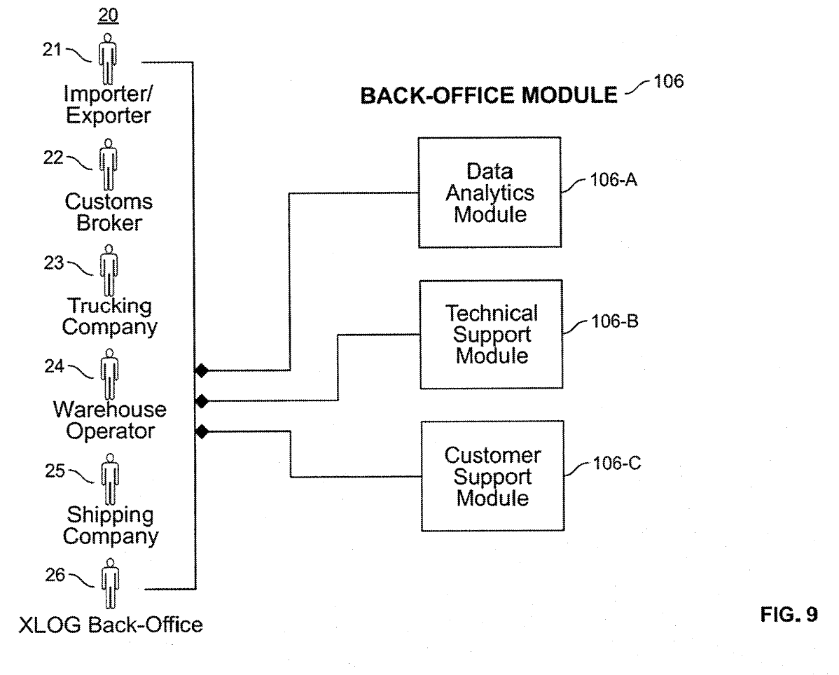

FIG. 9 shows the back-office module 106 of FIGS. 1-3 according to an example embodiment of the present invention. The back-office module 106 uses all of the available, incoming and historical data inside the system to proactively manage the various real-time transactions inside the system and in collaboration with other third-party applications (software). In this way the back-office module 106 has a Data Analytics Module 106-A for communicating with the participants or users 20 with regard to data analytics, forecasting, black-box inquiry reports, performance dashboards, reporting, etc. Technical Support Module 106-B relates to technical support for internal and external users 20 of the system. Customer support module 106-C carries out a customer support/ticketing system for reported incidents from internal and external customers/users. XLOG Back-office 26 can control Back-Office Module 106 to interact with other users 21-25.

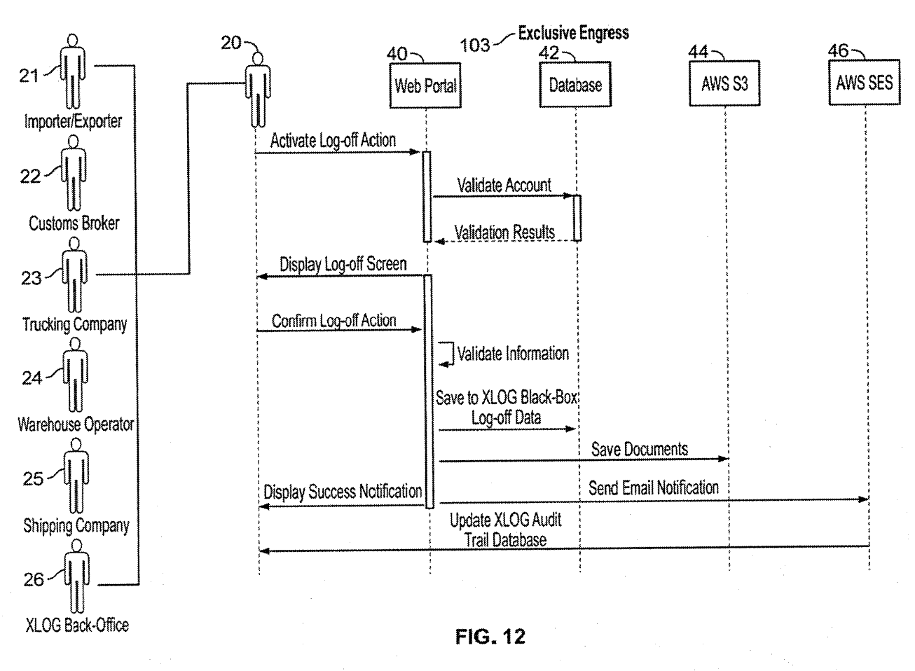

FIG. 12 shows a detailed view of the exclusive egress module 103 shown in FIG. 2 and FIG. 3 and its processes according to an example embodiment of the present invention. FIG. 12 includes a web portal 40, a database 42, a cloud storage (such as an Amazon Web Services Simple Storage Service (AWS S3)) 44, and a cloud email service (such as an Amazon Simple Email Services (AWS SES)) 46. Thus, the exclusive egress module 103 may be implemented through the facility of Amazon Web Services (AWS) for third party applications, for example. The Application Program Interface (API) setup under AWS allows for a highly efficient and secure method for online/real-time integration with various systems outside of the system of the present invention. A user of the system does not have to worry about how the system integrates with various systems that are not originally a part thereof. The API component handles this integration requirement.

In FIG. 12 the user 20 activates a log-off action through a web portal 40 and if the account is validated then database 42 stores the results. A logoff screen is then displayed to the user 20 by the web portal 40, and the web portal 40 requests that the user confirm the logoff action, at which time the data is validated and a notification of a successful logout is displayed to the user and the audit trail database is updated. All of the logoff data, documents, and email notifications/confirmations can be saved to the black-box module 105.

FIG. 11 shows a sample screenshot illustrating the home screen for a shipper or exporter/importer 21, for example. This can be referred to as the system's Cockpit.

The Cockpit contains the following major elements: (a) the name, photo, and related information about the user who is logged into the system; (b) the menu options available to the user; (c) the historical transactions related to the user; (d) the respective team the user has selected for each transaction created using the system; (e) basic shipping information such as date, time, location, and other related information per shipment or XLOG transaction; (f) the option to “START” or commence an end-to-end import or export process and communication with all parties involved; (g) a map showing the near real-time location of the shipment (land and ocean); and (h) an inside the system communication facility.

The system of the present invention can accommodate several major types of users. A user or participant 20 is a person who is registered in the system. The following list includes notable types or User Roles of the users 20, although this list is not meant to be exhaustive: shipper (importer/exporter) 21; customs broker 22; trucking company/truck owner 23; warehouse company/warehouse owner 24; shipping company or carrier 25; back-office employees of the system 26.

Each user or participant 20 has his or her own Cockpit (dashboard). A user 20 can change his or her User Roles allowed and registered into the system without the need to log out and again log in. All transactions inside the system can be stored in a “Black-Box.” This Black-Box is the storage of some or all transactions inside the system. This serves as a fully reliable reference for existing shipments/transactions and for historical shipments/transactions.

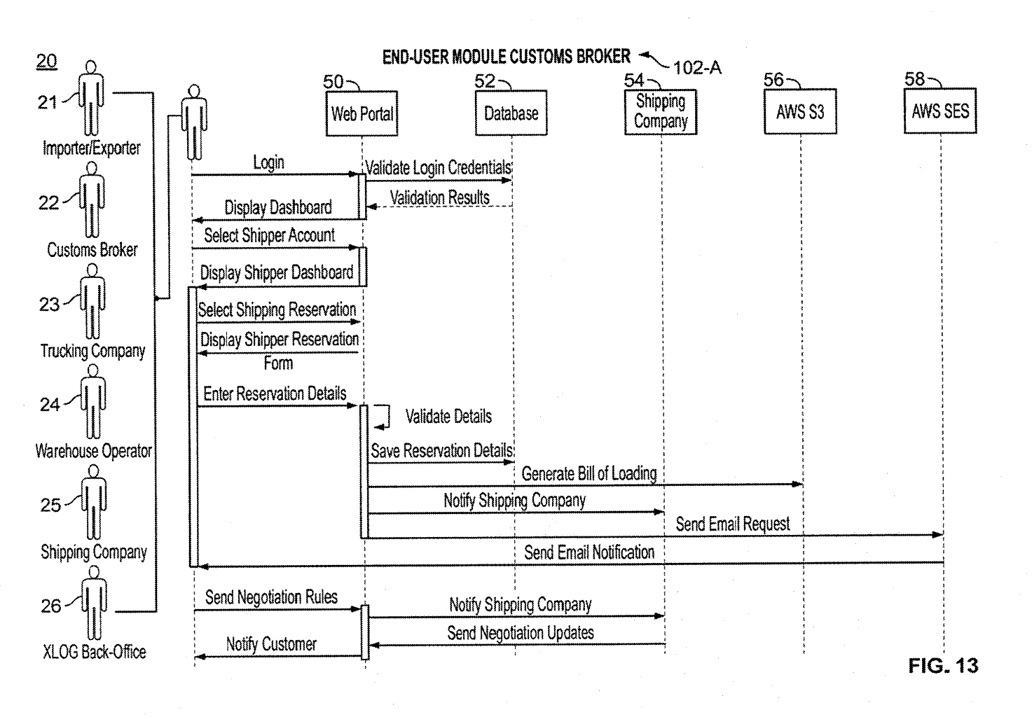

FIG. 13 shows an example of a sub-module 102-A within the end-user module 102 of FIGS. 1-3, interacting with a customs broker 22 in particular. This can be structured as a customs broker module 102-A within the end-user module 102. The customs-broker module 102-A can interact with the user 20 through a web portal 50 and communicate with a database 52, a shipping company module 54, a cloud storage (AWS S3) 56, and a cloud email service provider (AWS SES) 58. The customs-broker module 102-A allows online collaboration with all of the stakeholders in the import and export process. The initial booking or reservation is initiated and completed using the system. The customs-broker module 102-A may be implemented through the facility of Amazon Web Services (AWS) for third party applications, for example. The Application Program Interface (API) setup under AWS allows for a highly efficient and secure method for online/real-time integration with various systems outside of the system of the present invention. A user of the system does not have to worry about how the system integrates with various systems that are not originally a part thereof. The API component handles this integration requirement. AWS S3 56 is the storage of the output from the activities by the customs broker 22. Such outputs could include (but are not limited to) digital documents, drawings, scanned images, related materials, etc. AWS SES 58 is the component of the system 100 that allows the sending and management of emails to concerned parties of the system 100.

As shown in FIG. 13 the web portal 50 handles a login attempt by the customs broker 22. Login credentials are validated and stored in the database 52. Upon validation a dashboard is displayed to the customs broker 22 by the web portal 50. From the dashboard the customs broker 22 can select a shipper account to carry out a shipping reservation, after which a shipping reservation form is shown on the dashboard in which the customs broker 22 can enter the reservation details. Once the details are validated, the reservation details are saved in the database 52, a bill of lading is generated and stored in AWS S3 56, and the shipping company is notified by the shipping company module 54. The web portal 50 can receive negotiation rates sent by the customs broker 22 and notify the shipping company module 54 which can in return send negotiation updates which the web portal 50 notifies the customer of.

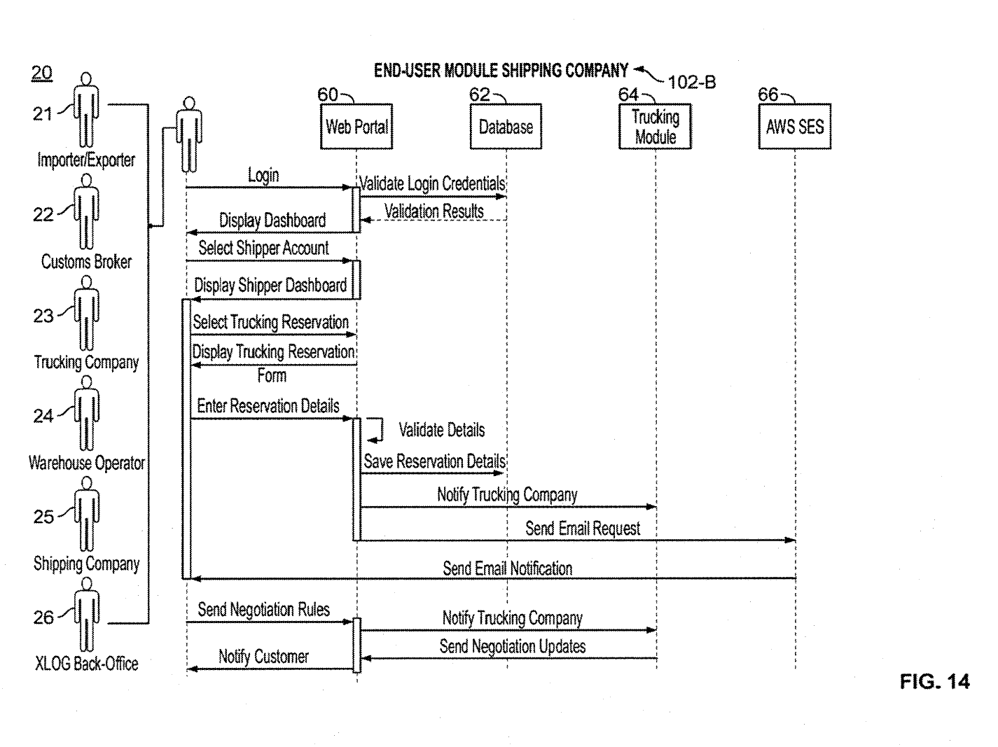

FIG. 14 shows an example of a sub-module 102-B within the end-user module 102 of FIGS. 1-3, interacting with a shipping company 25 in particular (or a representative thereof). This can be structured as a shipping company module 102-B within the end-user module 102. The shipping company module 102-B includes a web portal 60, a database 62, a trucking module 64, and an AWS SES 66. The shipping company module 102-B covers the unique online and procedural collaboration between the system of the present invention and the shipping company, after which the system handles the subsequent collaboration with the end-users 20. The shipping module 102-B may be implemented through the facility of Amazon Web Services (AWS) for third party applications, for example. The Application Program Interface (API) setup under AWS allows for a highly efficient and secure method for online/real-time integration with various systems outside of the system of the present invention. A user of the system does not have to worry about how the system integrates with various systems that are not originally a part thereof. The API component handles this integration requirement. AWS SES 66 is the email management system of the XLOG system 100, which allows the automated sending of emails to concerned parties in the system 100.

As shown in FIG. 14 the web portal 60 handles a login attempt by the shipping company 25. Login credentials are validated and stored in the database 62. Upon validation a dashboard is displayed to the shipping company 25 by the web portal 60. From the dashboard the shipping company 25 can select a shipper account and to carry out a shipping or trucking reservation, after which a shipping or trucking reservation form is shown on the dashboard in which the shipping company 25 can enter the reservation details. Once the details are validated the reservation details are saved in the database 62, and the shipping or trucking company is notified by the trucking module 64. The web portal 60 can receive negotiation rates sent by the shipping company 25 and notify the shipping or trucking company module 64 which can in return send negotiation updates which the web portal 60 notifies the customer of.

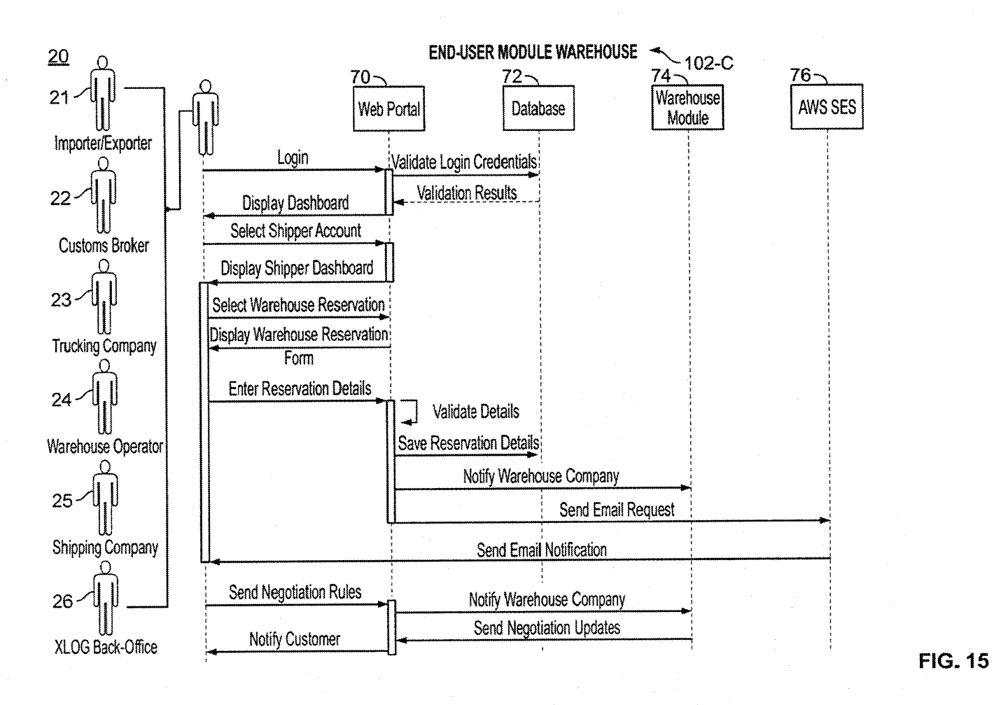

FIG. 15 shows an example of a sub-module 102-C within the end-user module 102 of FIGS. 1-3, interacting with a warehouse operator 24 in particular. This can be structured as a warehouse operator module 102-C within the end-user module 102. The warehouse operator module 102-C can interact with the user through a web portal 70 and communicate with a database 72, a warehouse module 74, and an AWS SES 76. The warehouse operator module 102-C handles the storage of shipments at the origin and destination sides when and if needed. The warehouse operator module 102-C enables online reservation and online payments for every stakeholder's ease of transaction with the system of the present invention. The warehouse operator module 102-C may be implemented through the facility of Amazon Web Services (AWS) for third party applications, for example. The Application Program Interface (API) setup under AWS allows for a highly efficient and secure method for online/real-time integration with various systems outside of the system of the present invention. A user of the system 100 does not have to worry about how the system 100 integrates with various systems that are not originally a part thereof. The API component handles this integration requirement. The AWS SES 76 is the email management system of the XLOG system 100; it is part of Amazon Web Services (AMS).

As shown in FIG. 15 the web portal 70 handles a login attempt by the warehouse operator 24. Login credentials are validated and stored in the database 72. Upon validation a dashboard is displayed to the warehouse operator 24 by the web portal 70. From the dashboard the warehouse operator 24 can select a shipper account and to carry out a warehouse reservation, after which a warehouse reservation form is shown on the dashboard in which the warehouse operator 24 can enter the reservation details. Once the details are validated the reservation details are saved in the database 72, and the warehouse company is notified by the warehouse module 64. The web portal 70 can receive negotiation rates sent by the warehouse operator 24 and notify the warehouse module 74 which can in return send negotiation updates which the web portal 70 notifies the customer of.

It is noted that specific modules for importer/exporter 21, trucking company 23, back-office 26, and others are not described herein but these would be similar in many relevant respects to those described above in connection with sub-modules 102-A, 102-B, and 102-C of FIGS. 13, 14, and 15, respectively. Thus, it is of course to be understood that while FIGS. 13, 14, and 15 provide examples of sub-modules 102-A, 102-B, and 102-C, respectively, for customs broker 22, shipping company 25, and warehouse operator 24, the present invention is not limited to these examples and of course other examples of other participants in other industries and for other applications are readily envisioned.

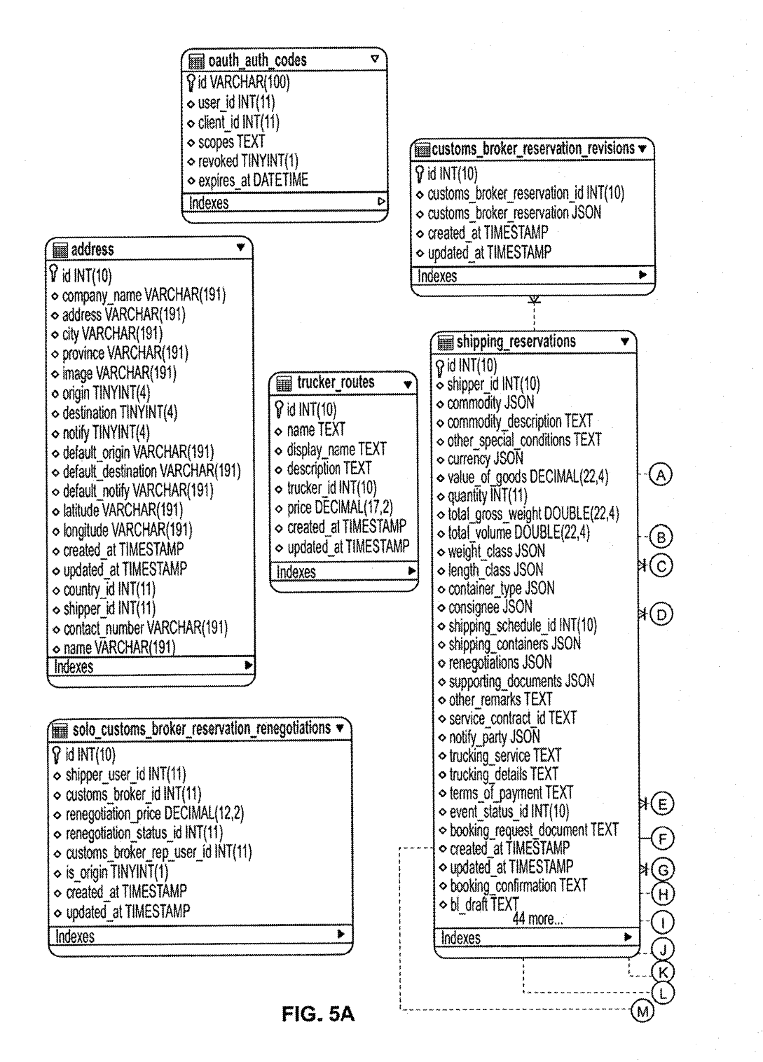

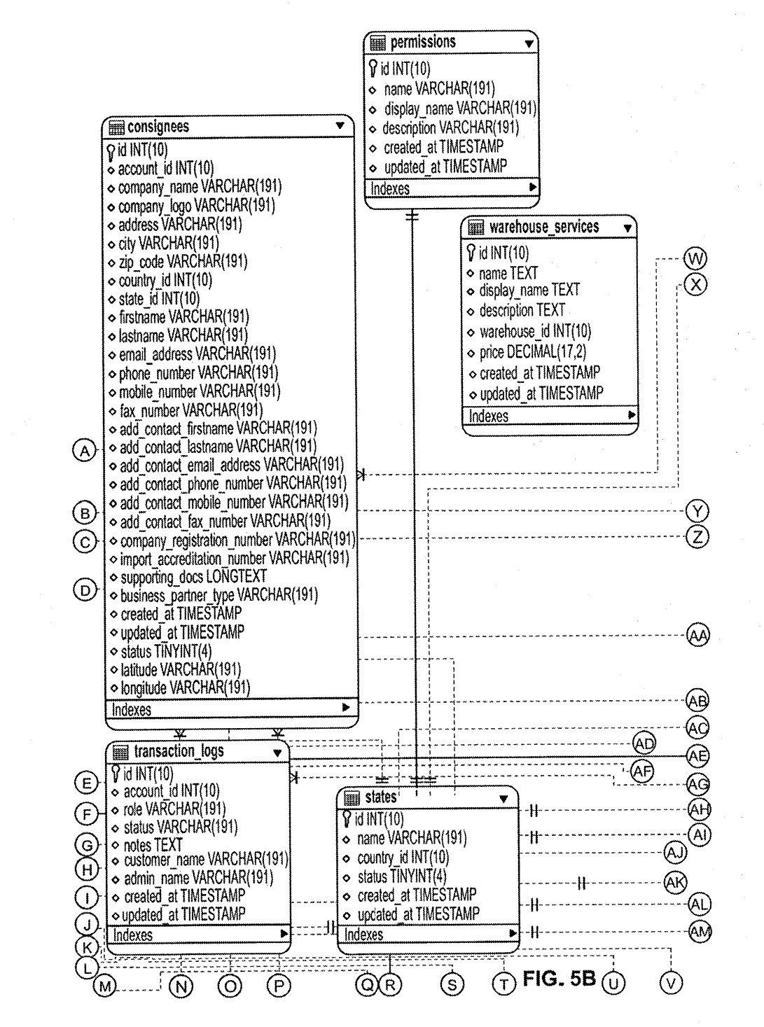

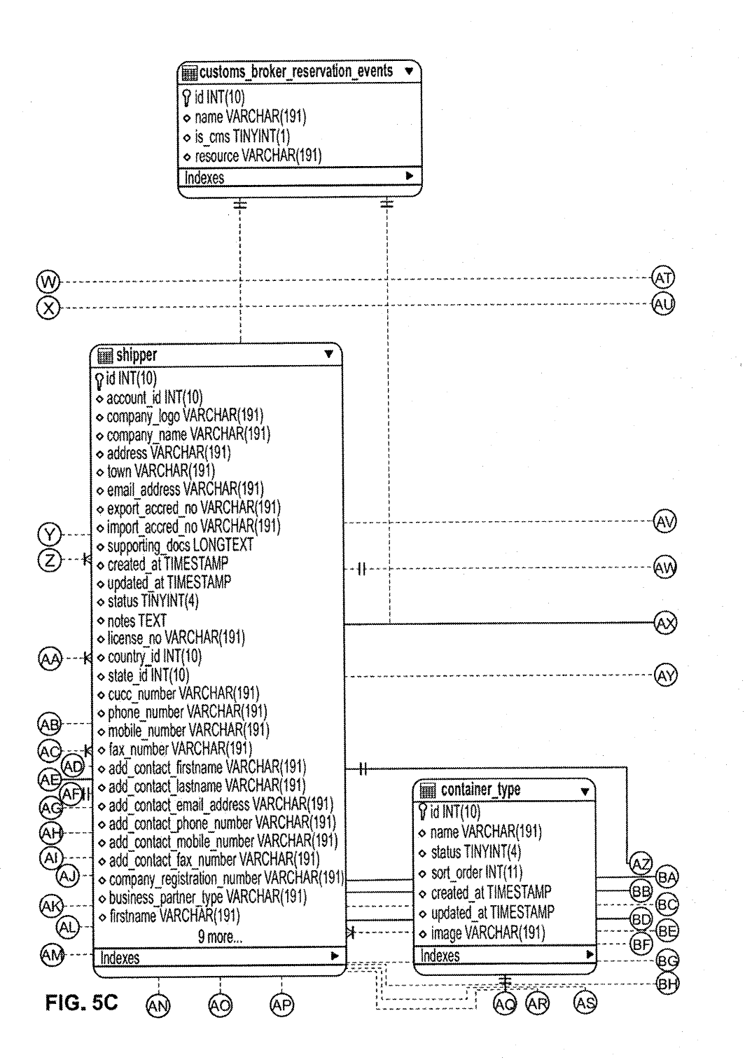

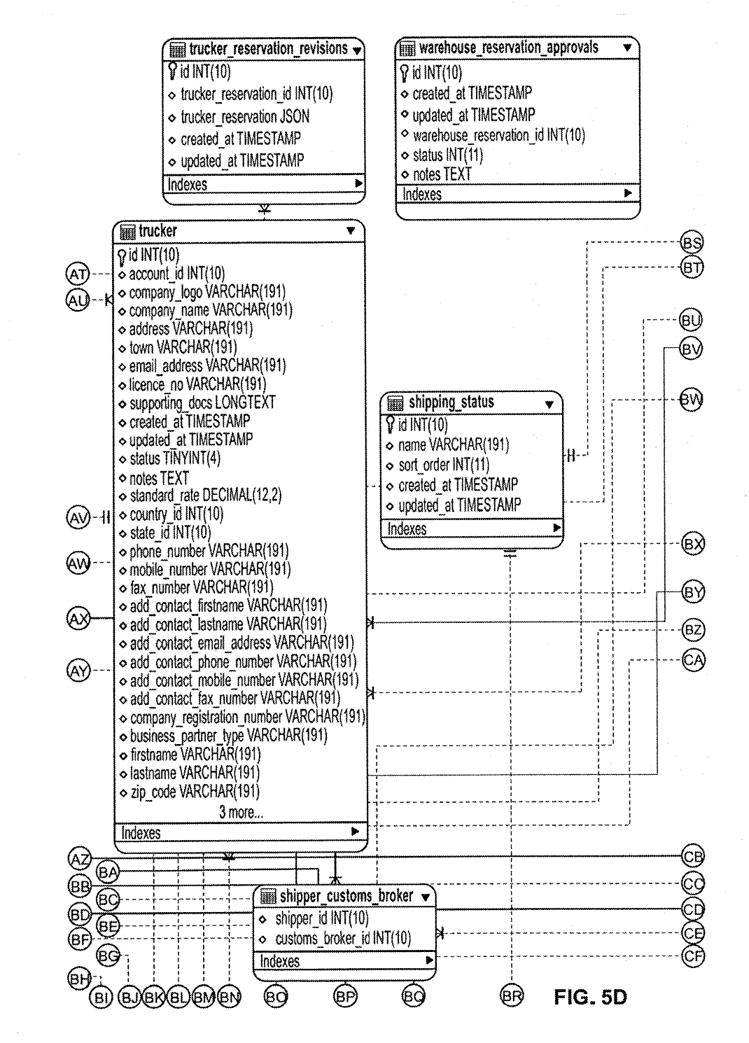

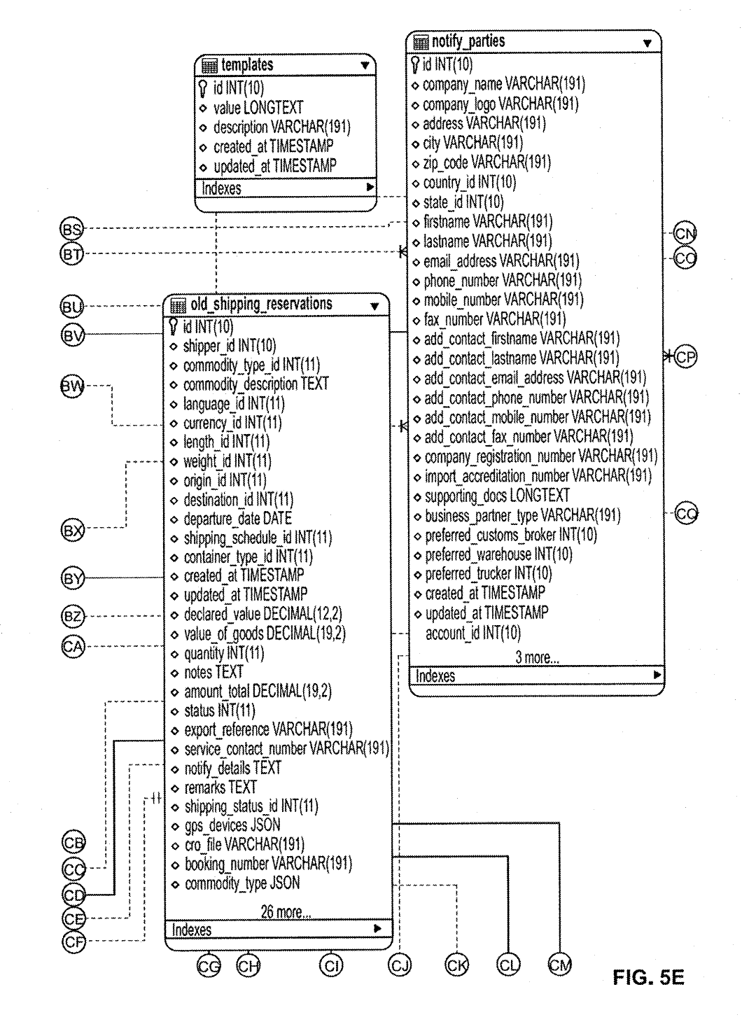

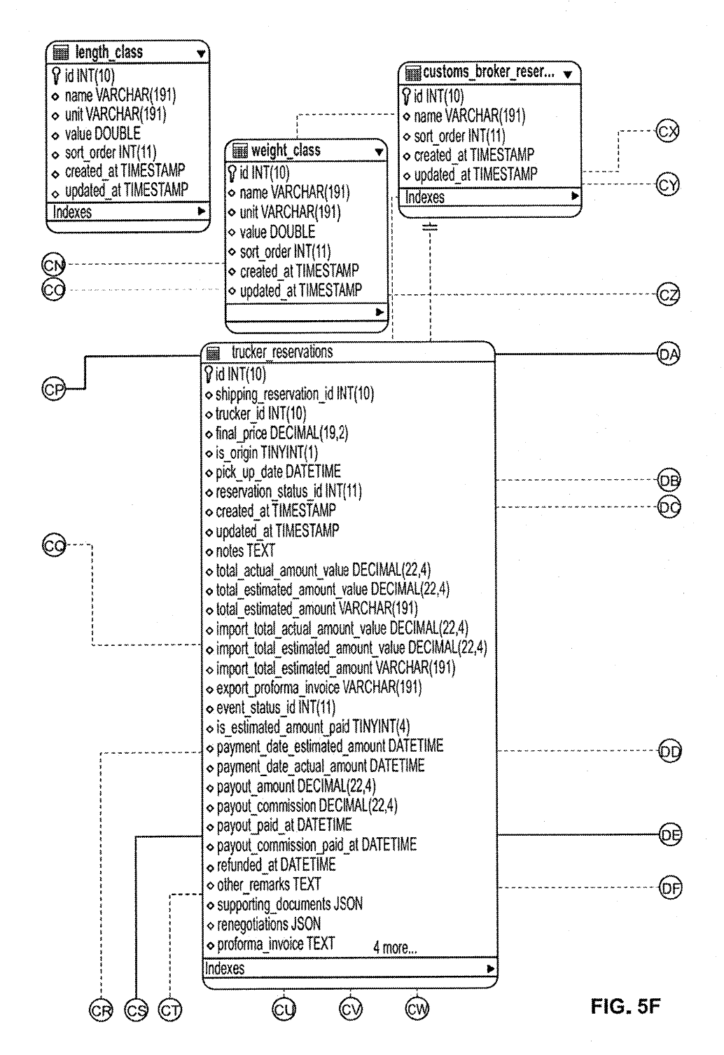

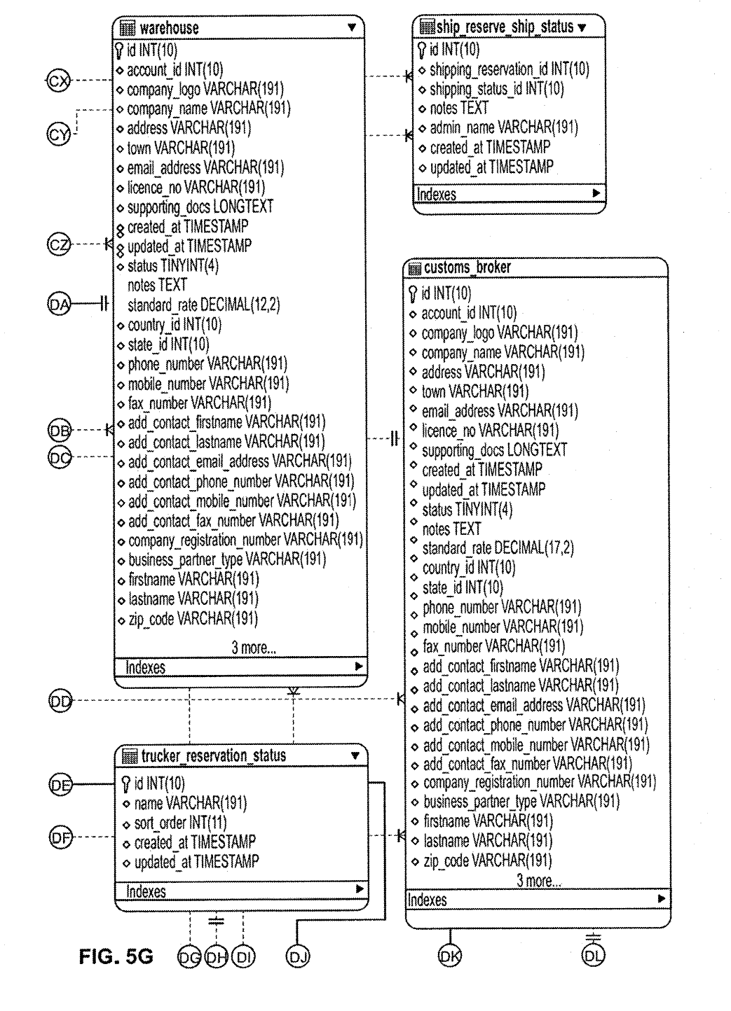

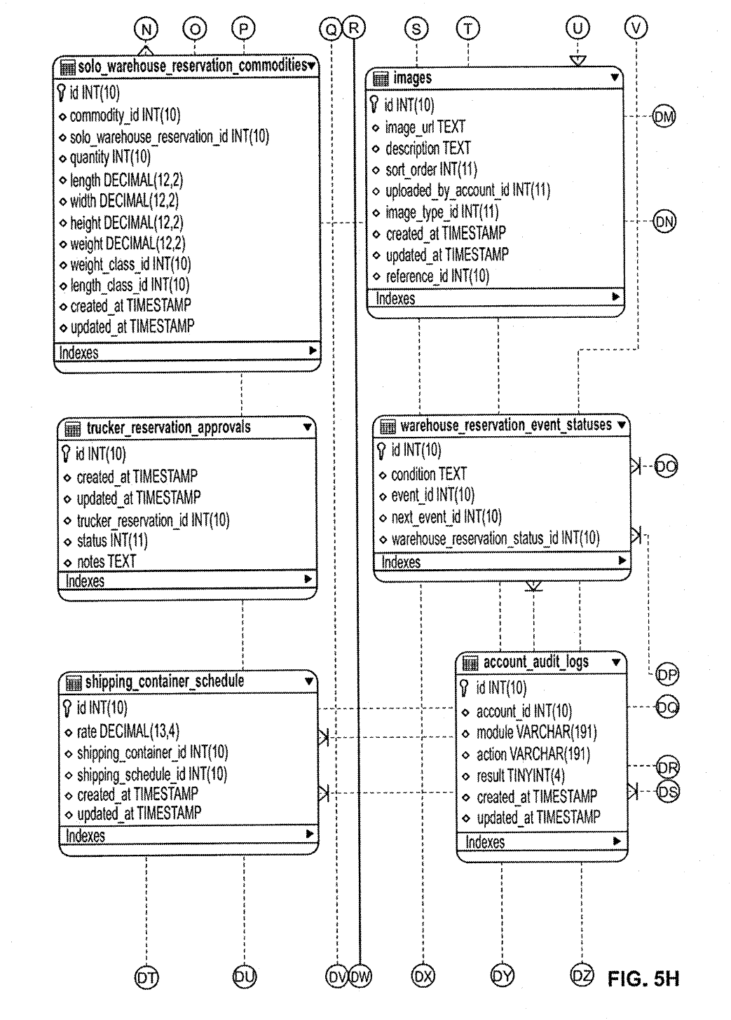

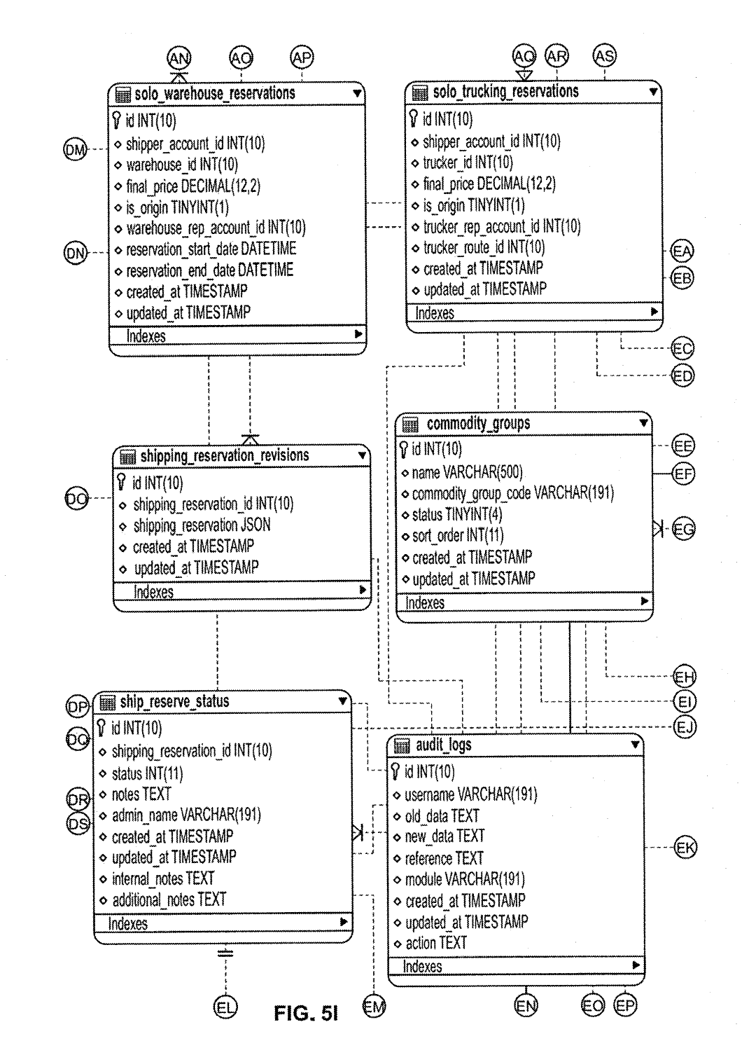

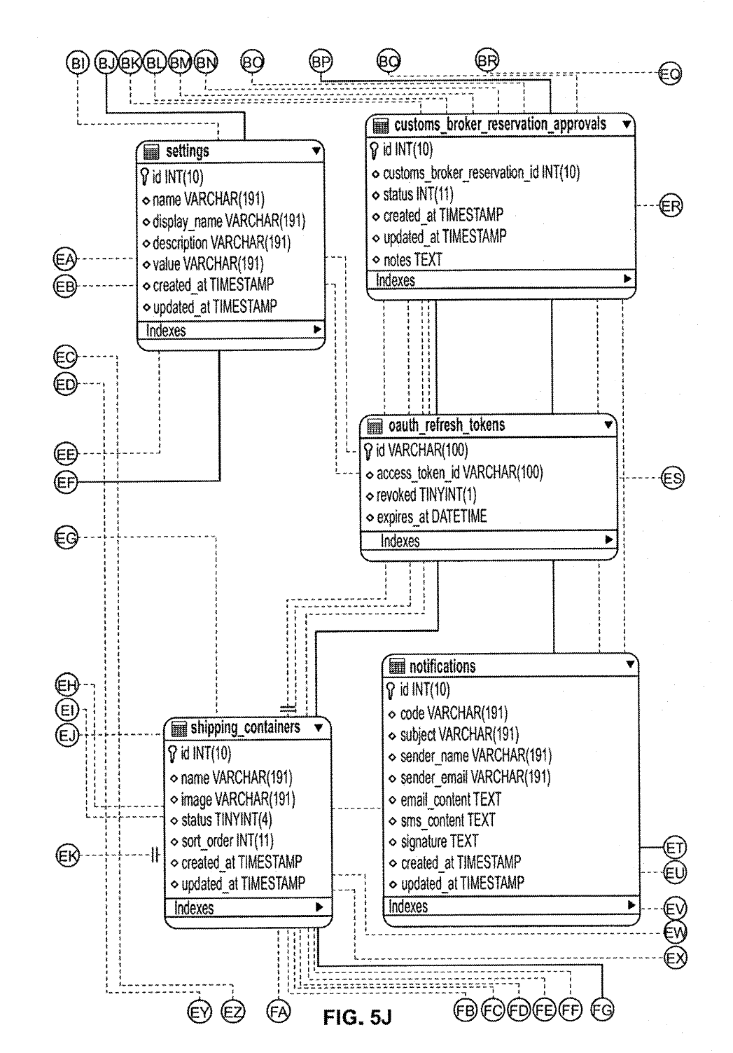

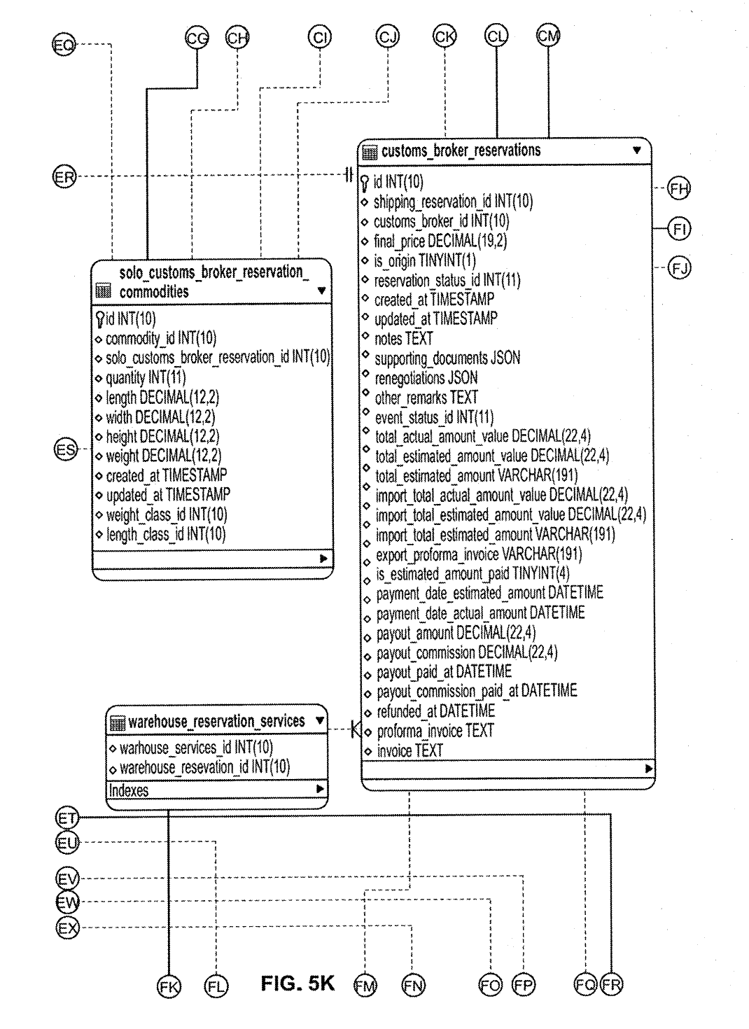

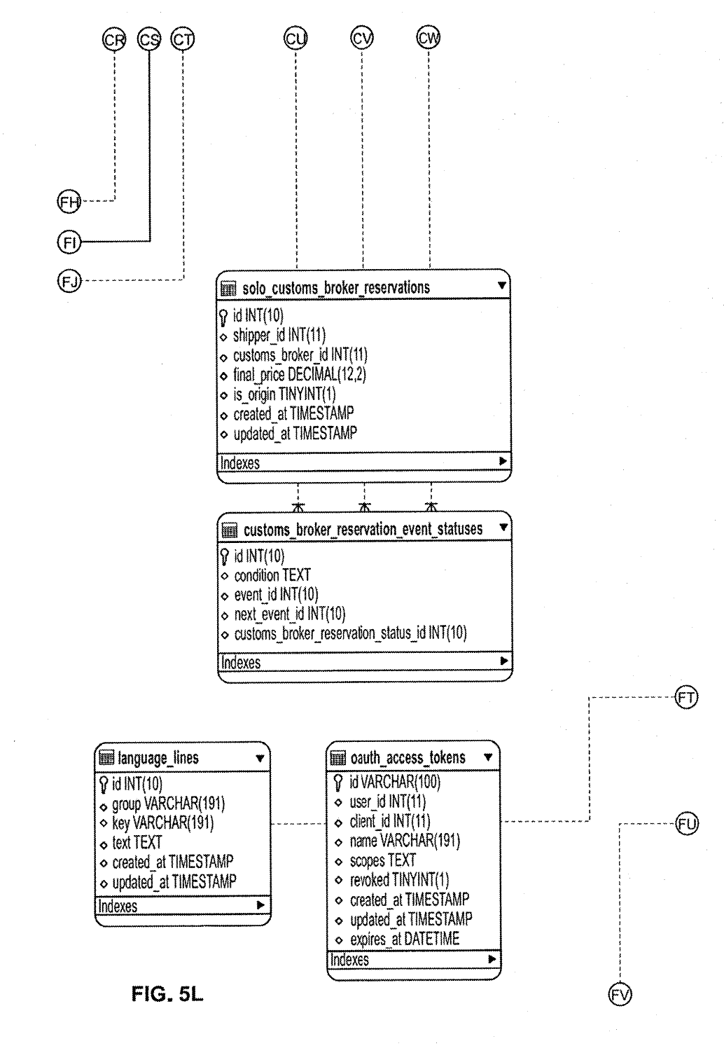

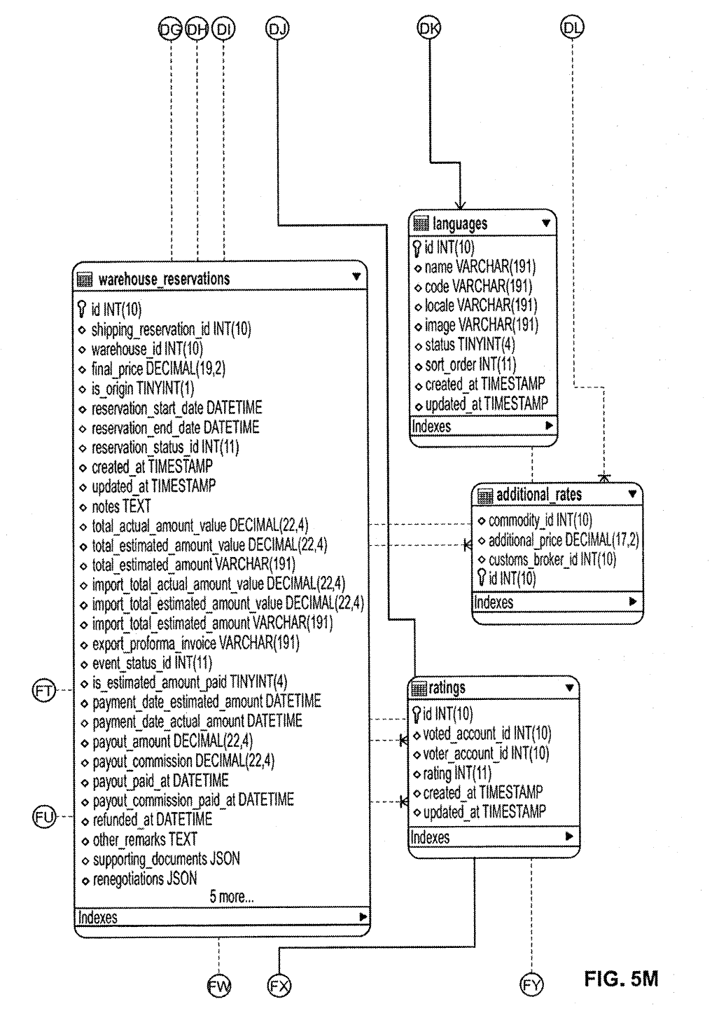

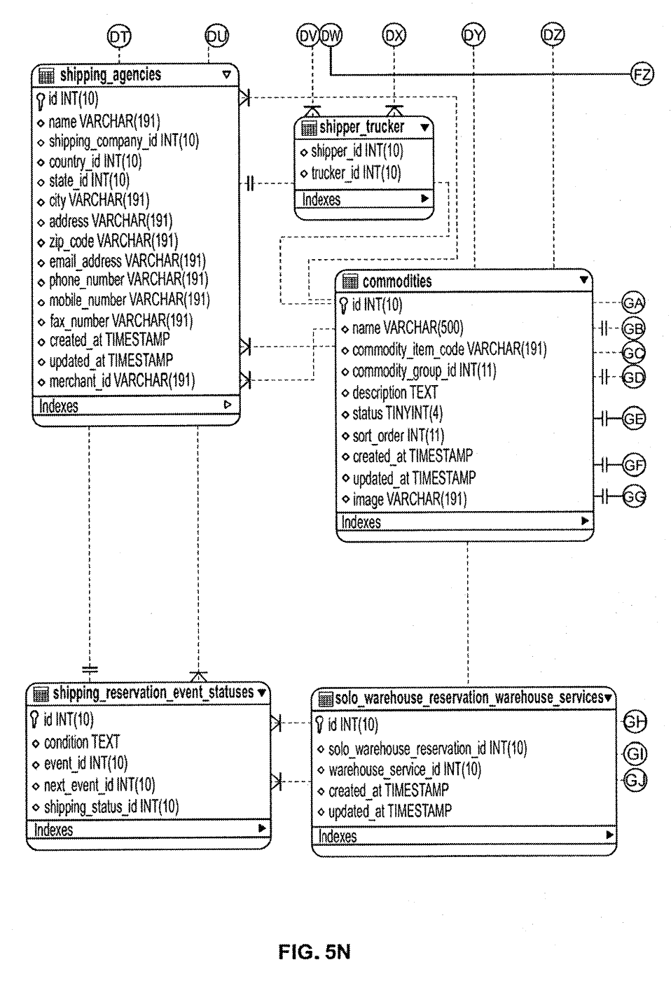

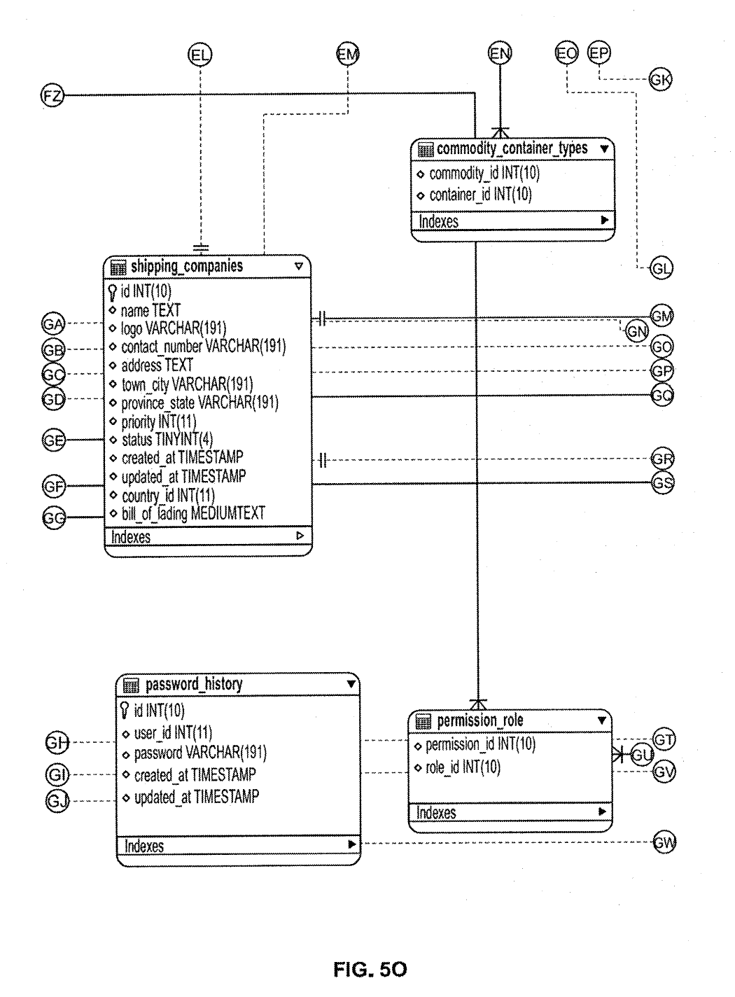

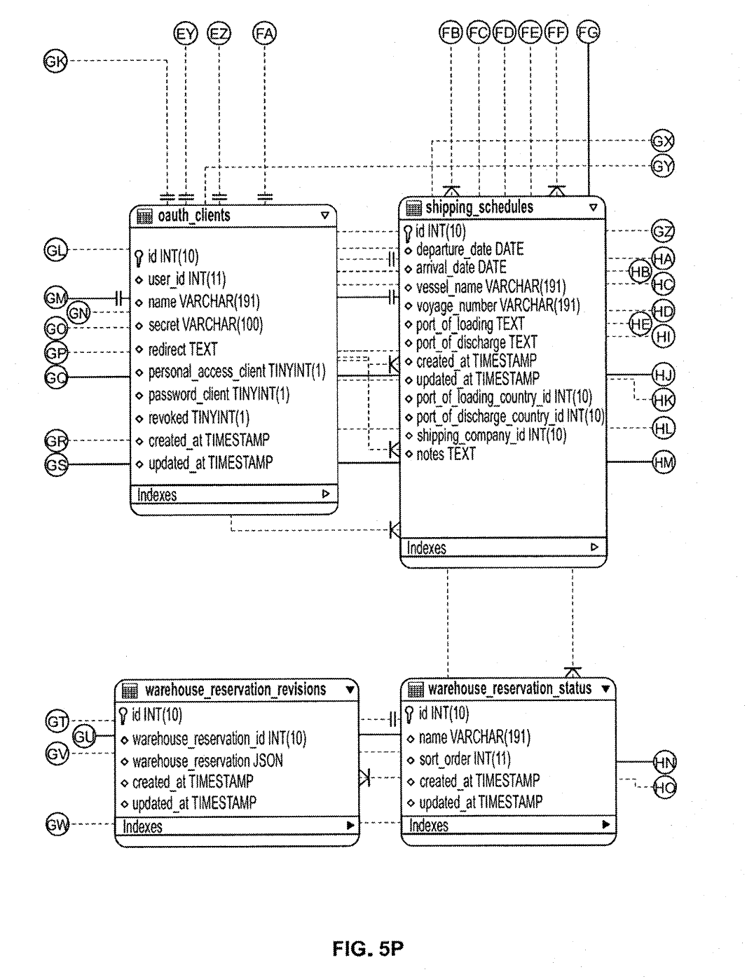

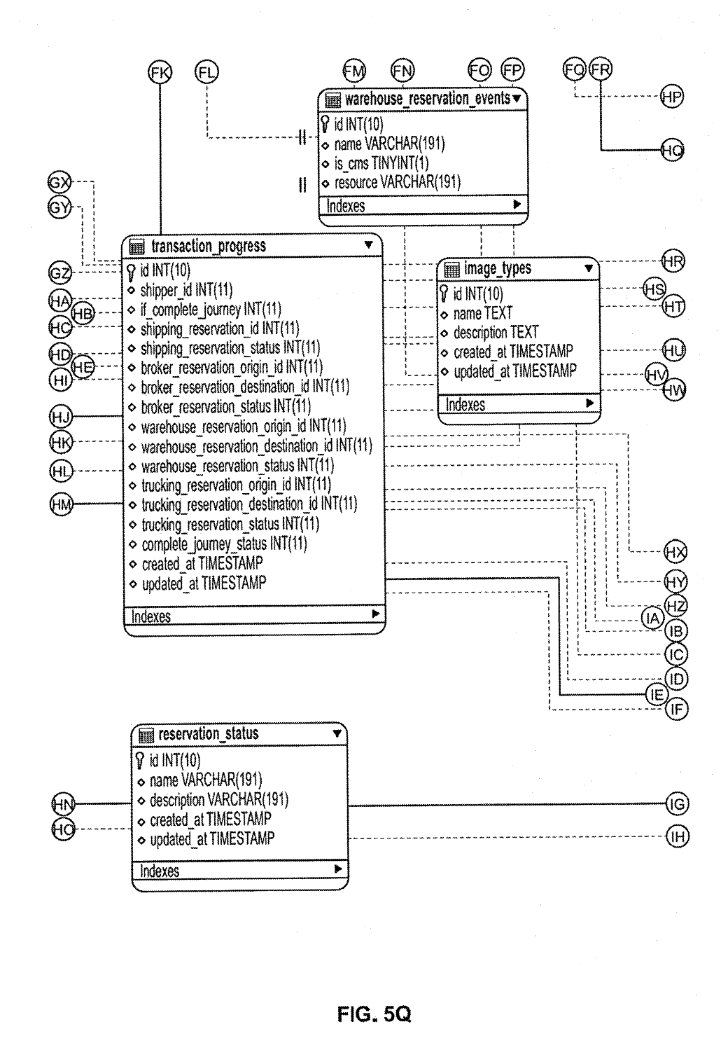

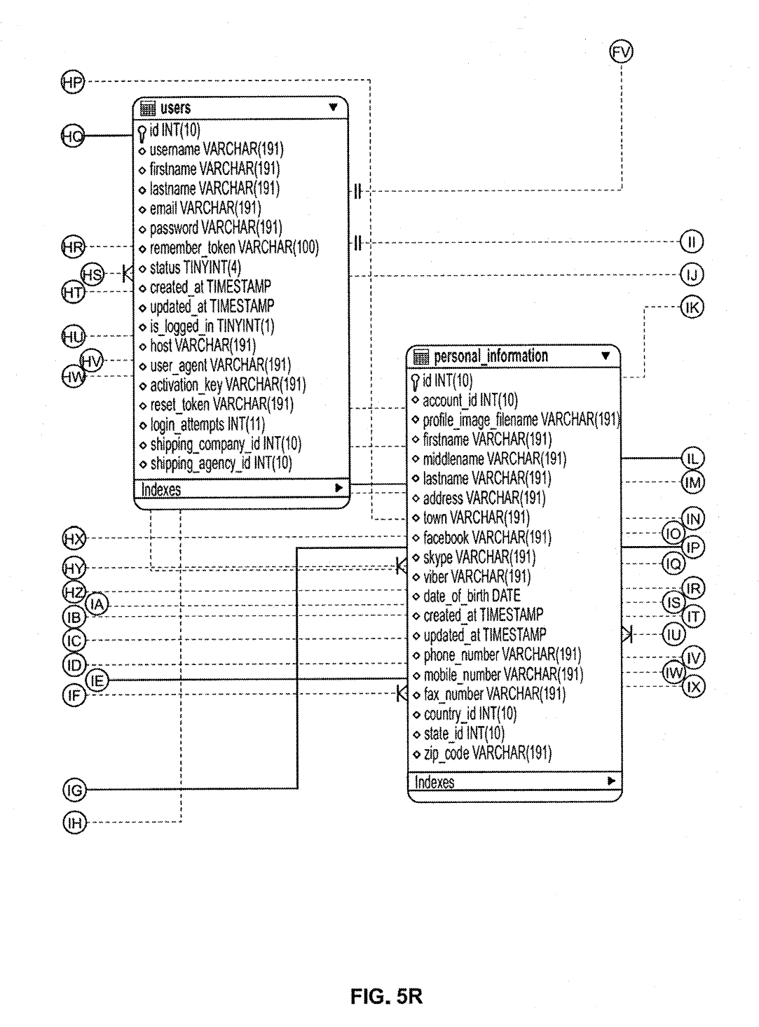

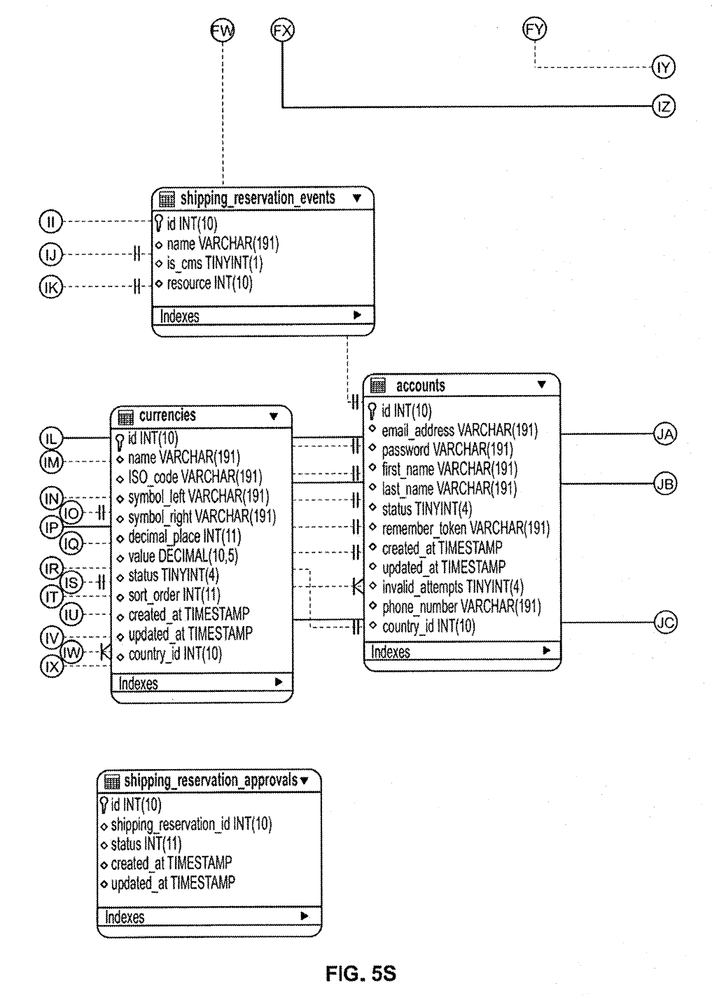

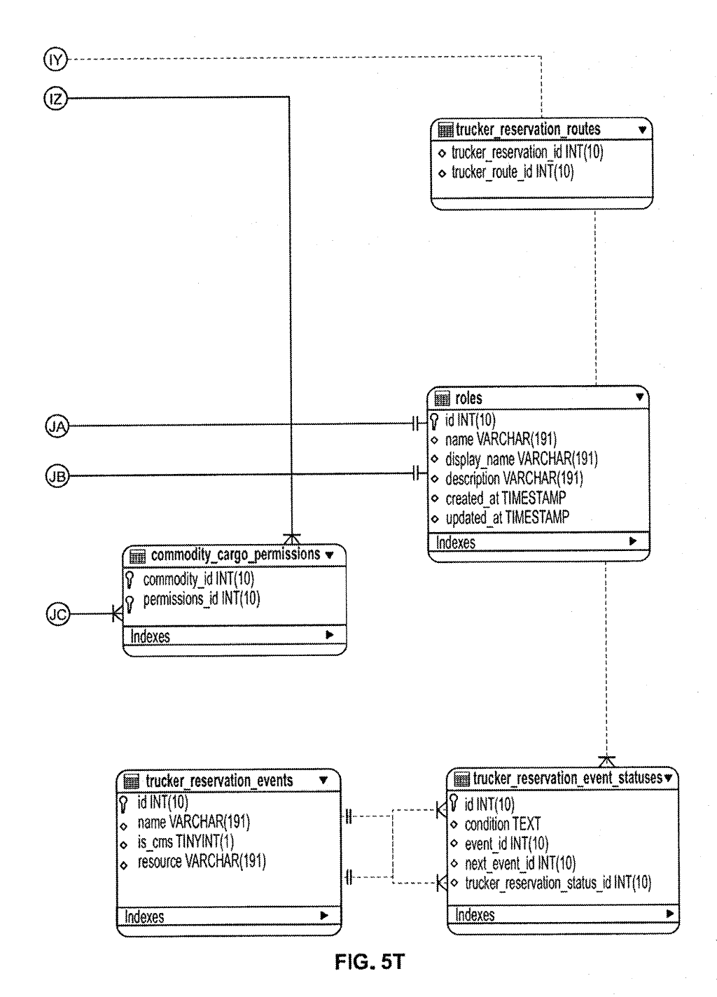

FIGS. 5A-T show the database design in an Entity Relationship Diagram (ERD), according to the present invention.

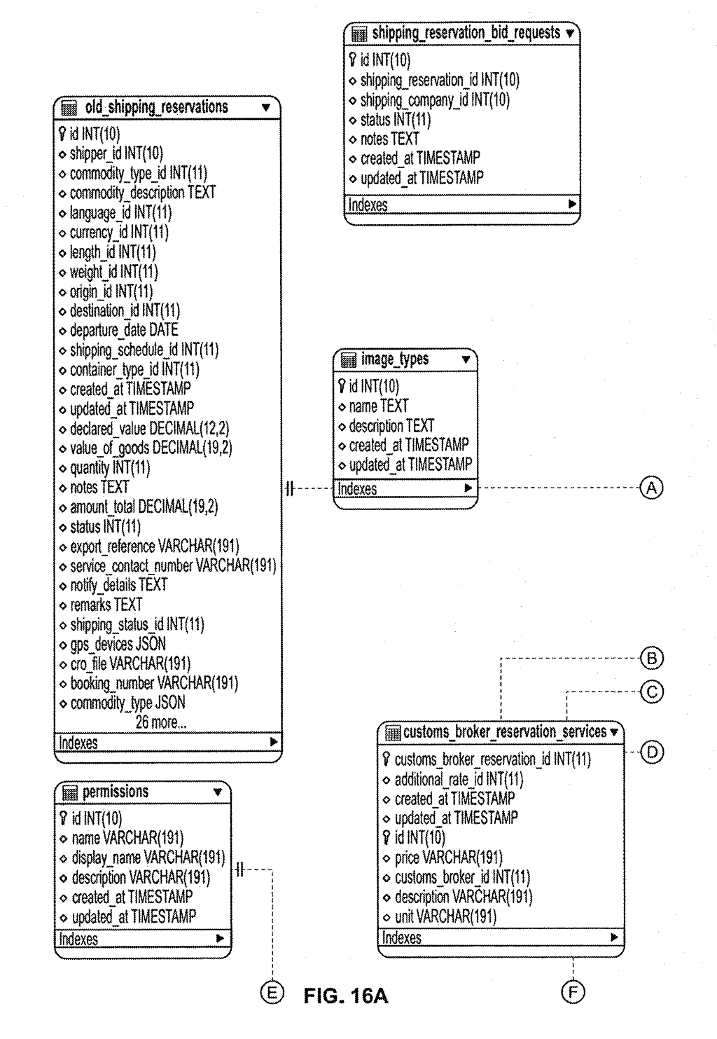

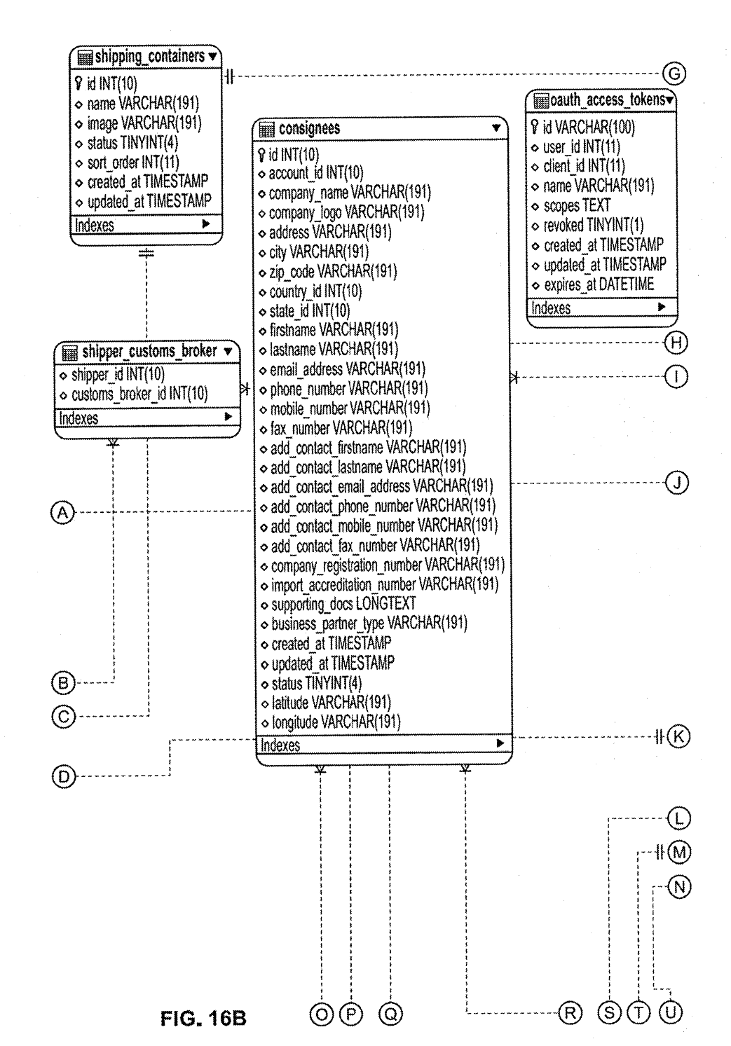

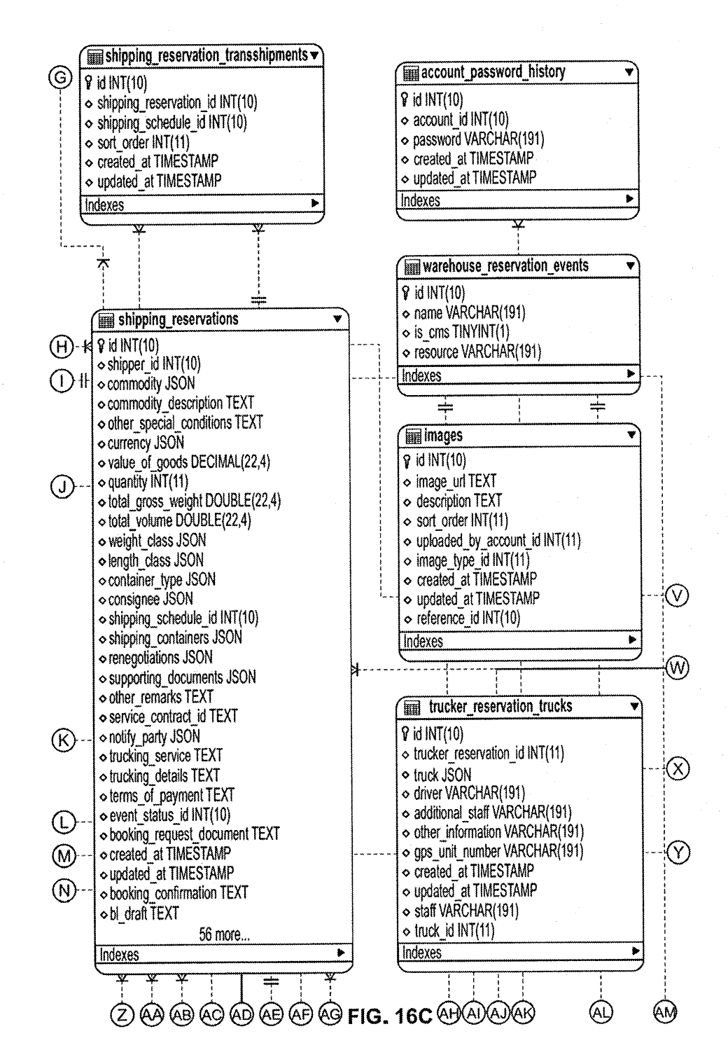

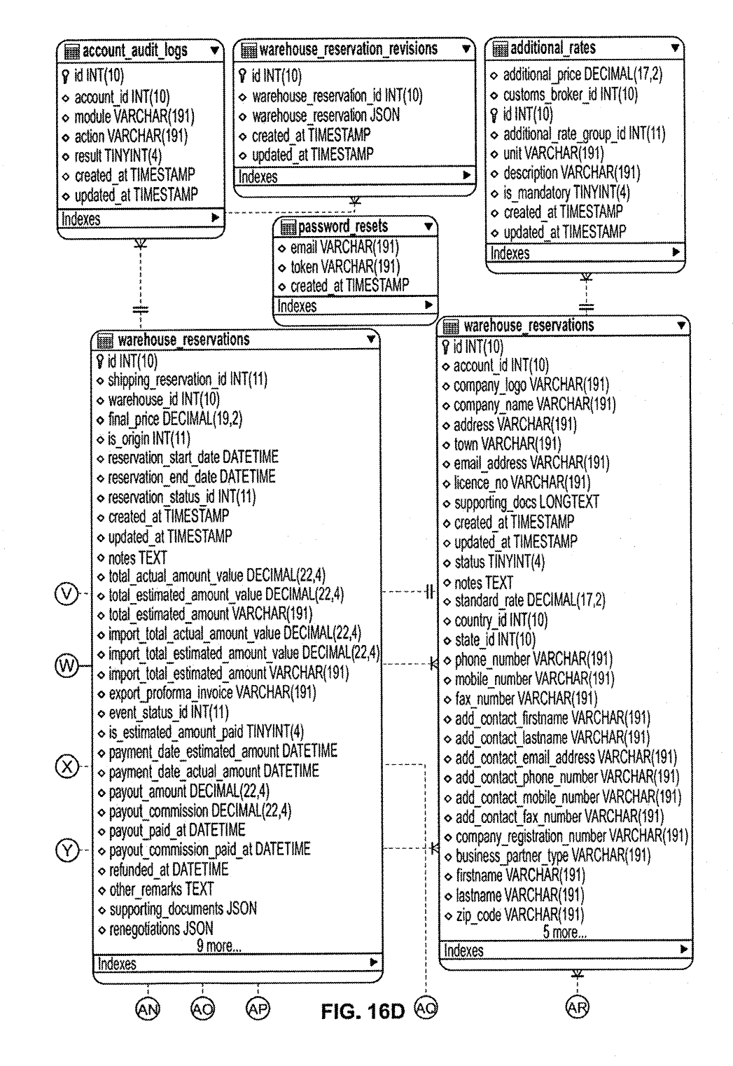

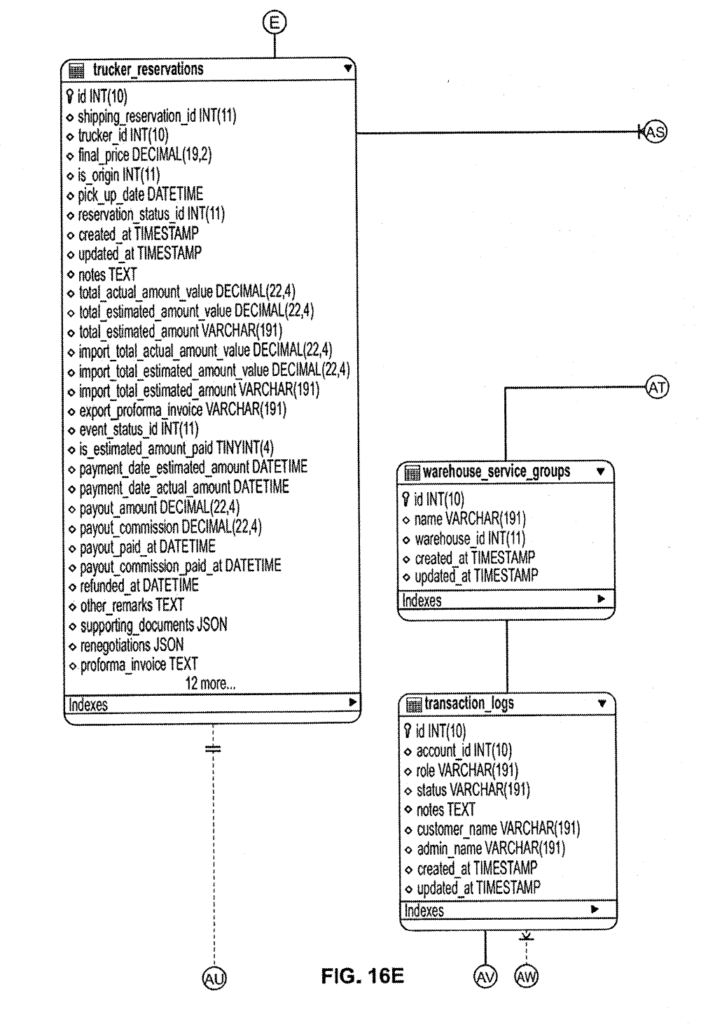

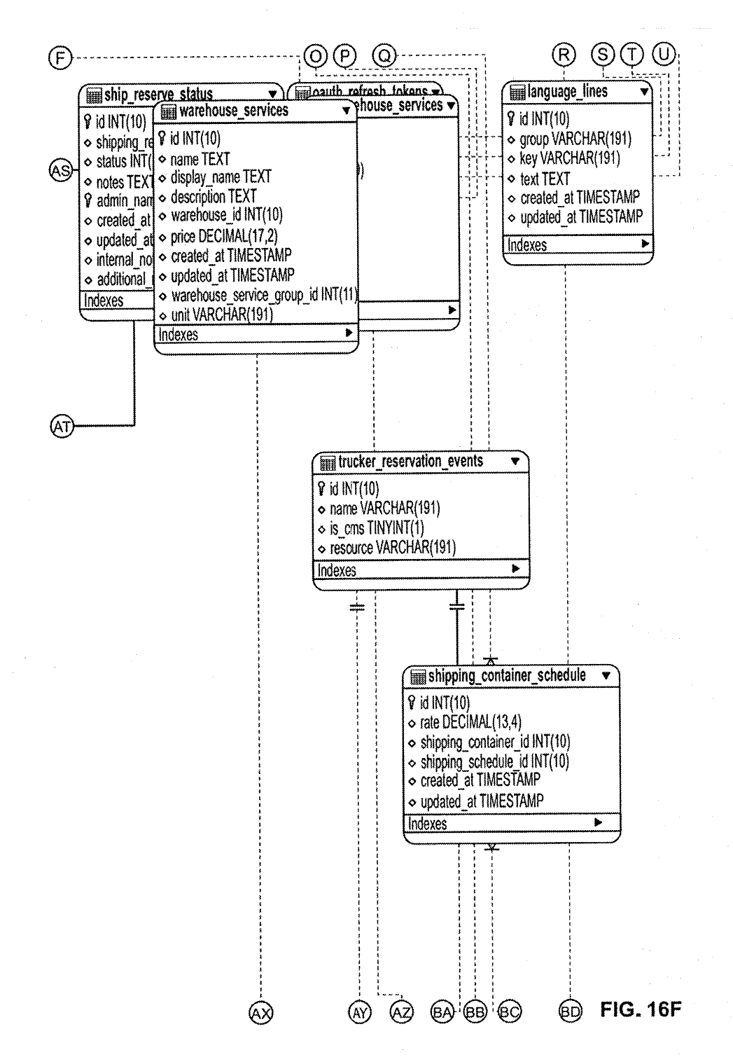

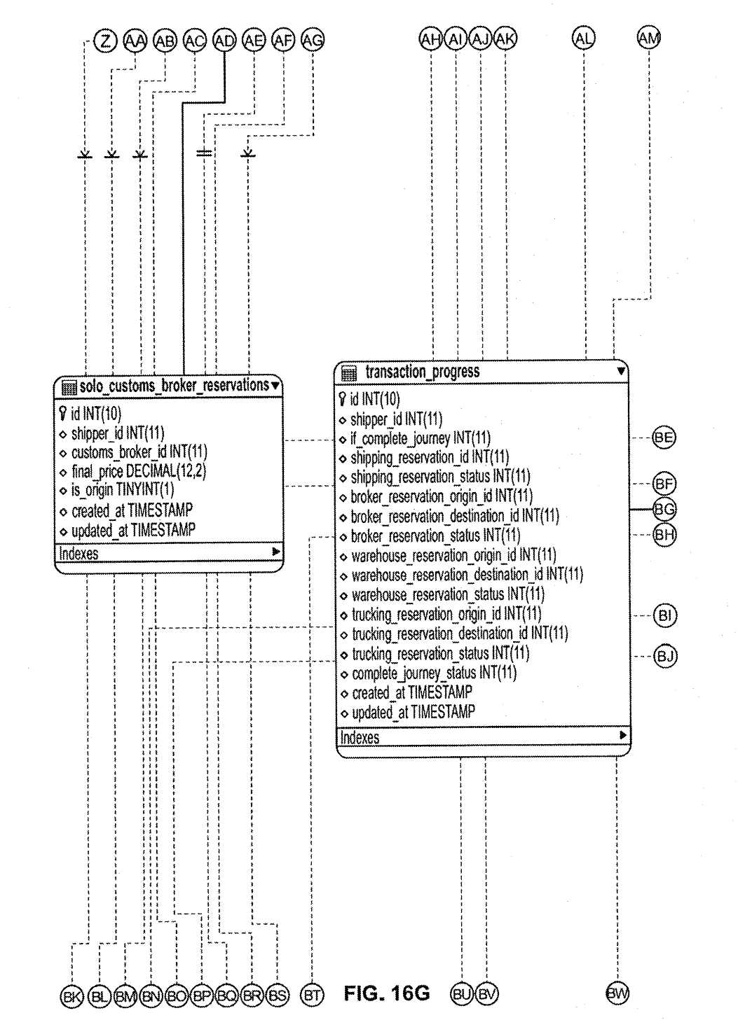

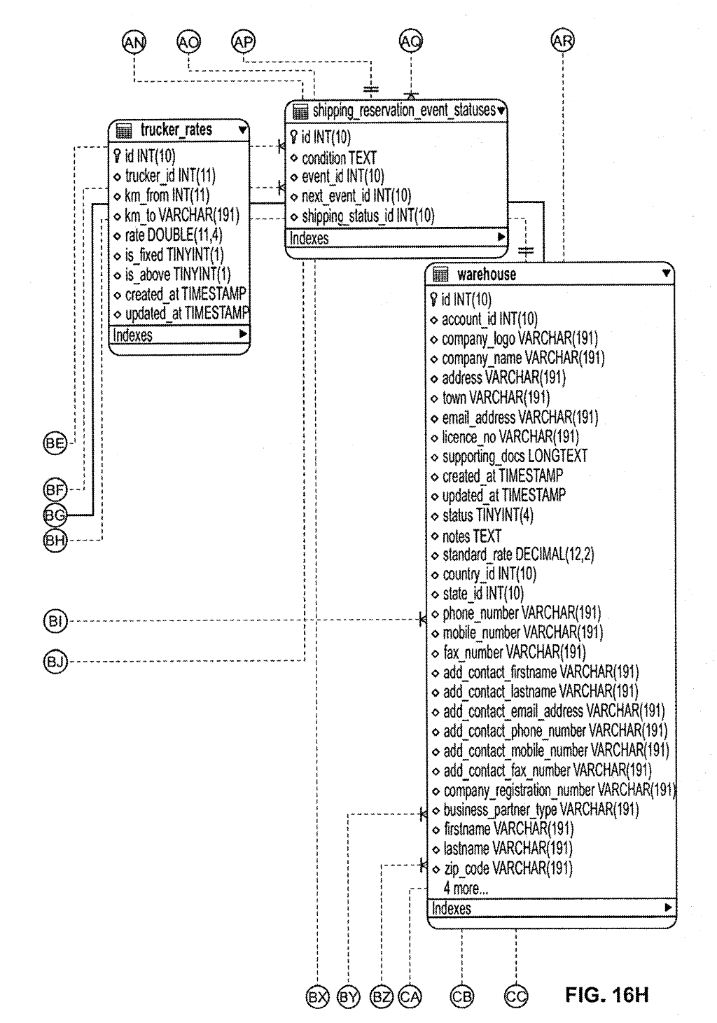

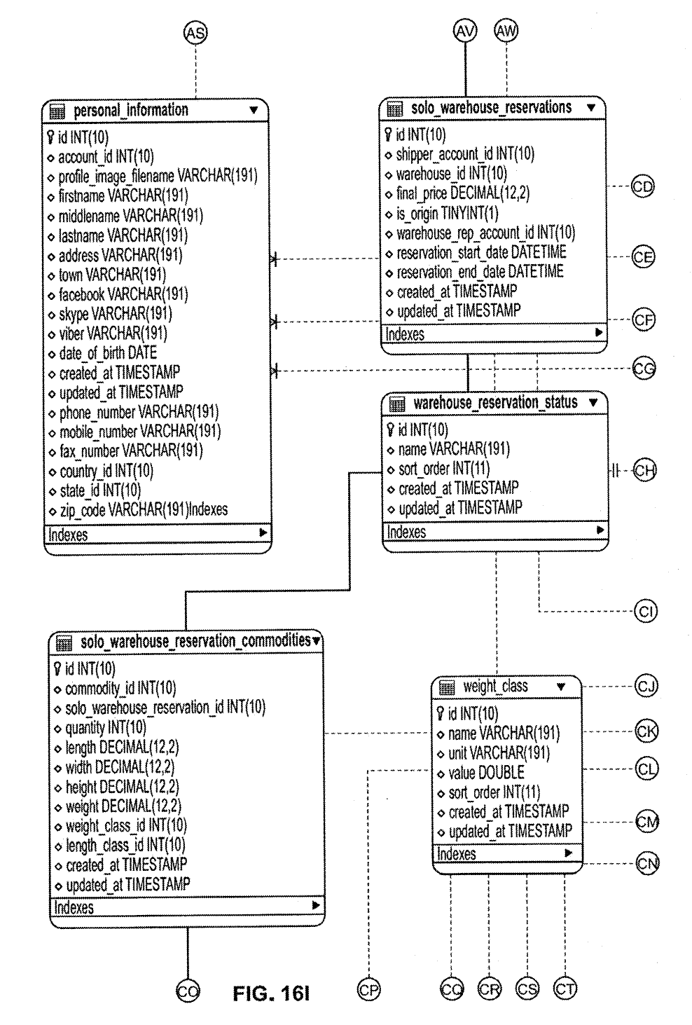

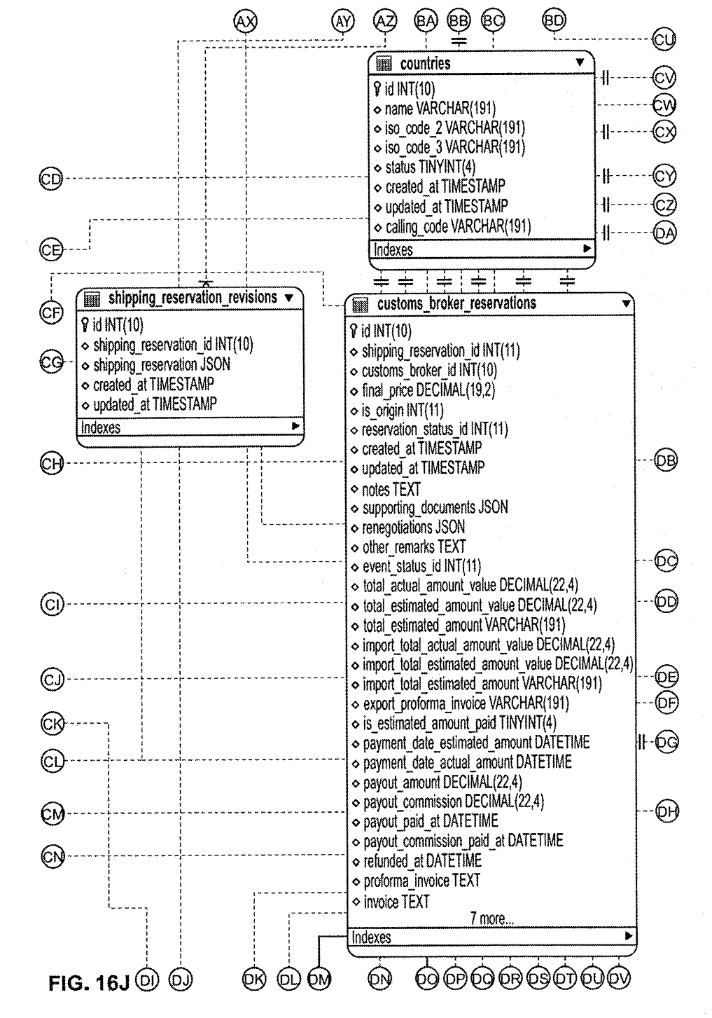

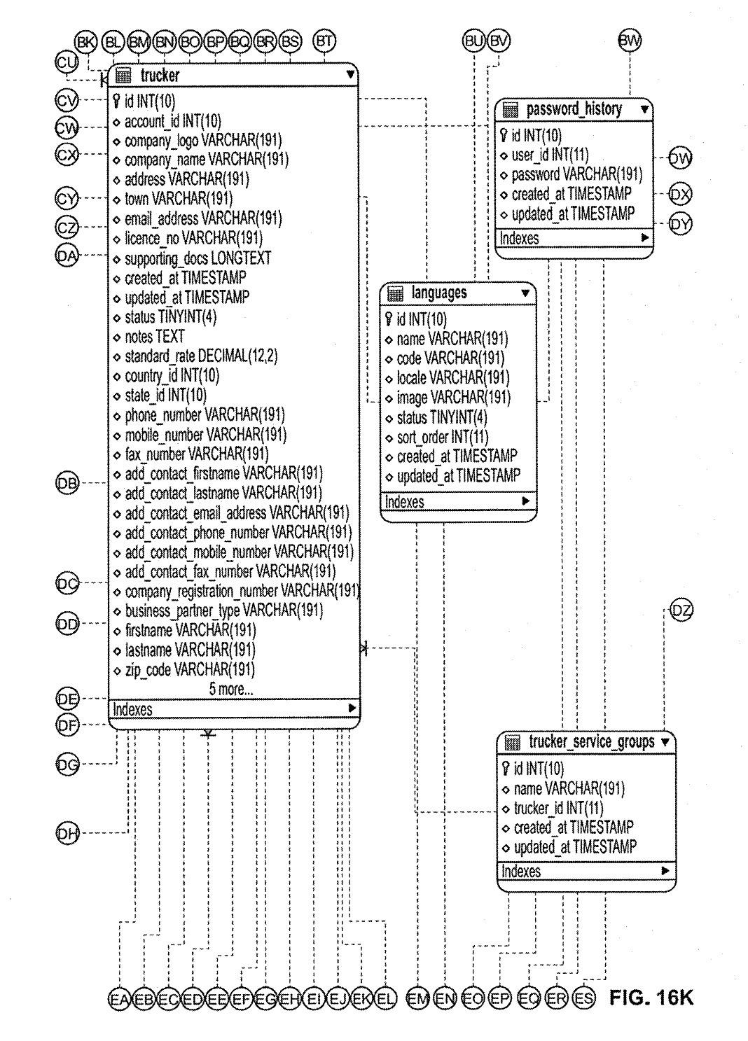

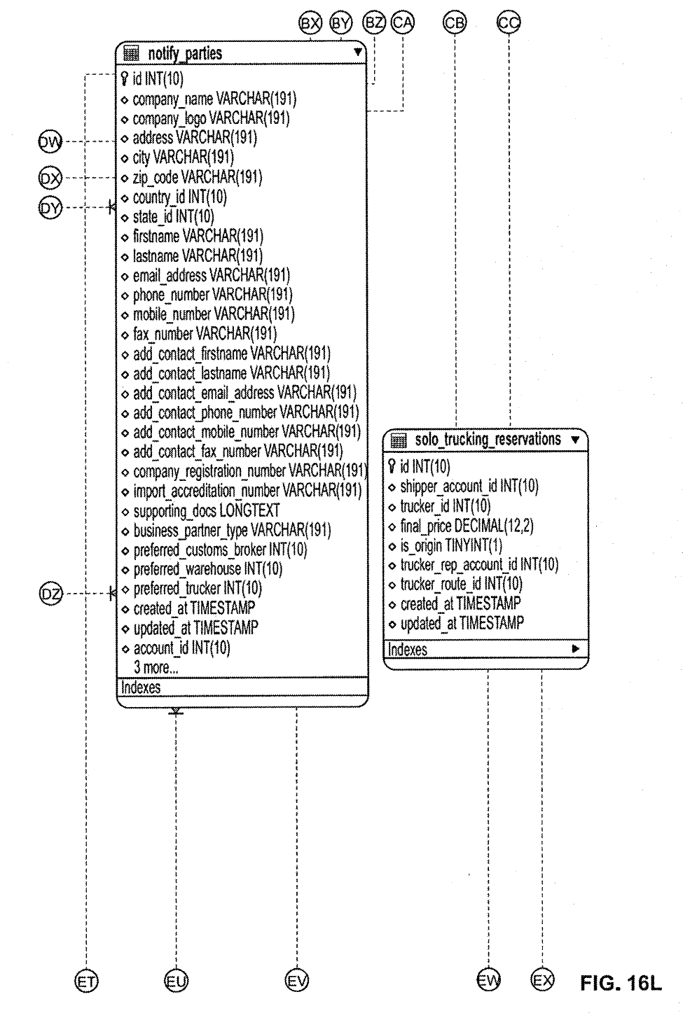

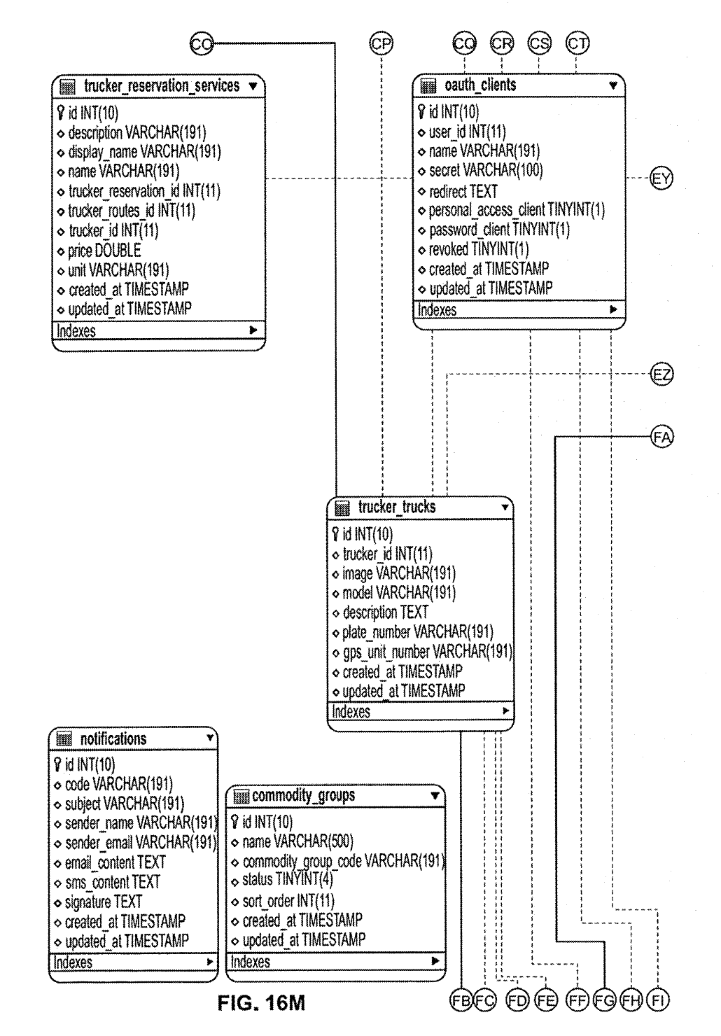

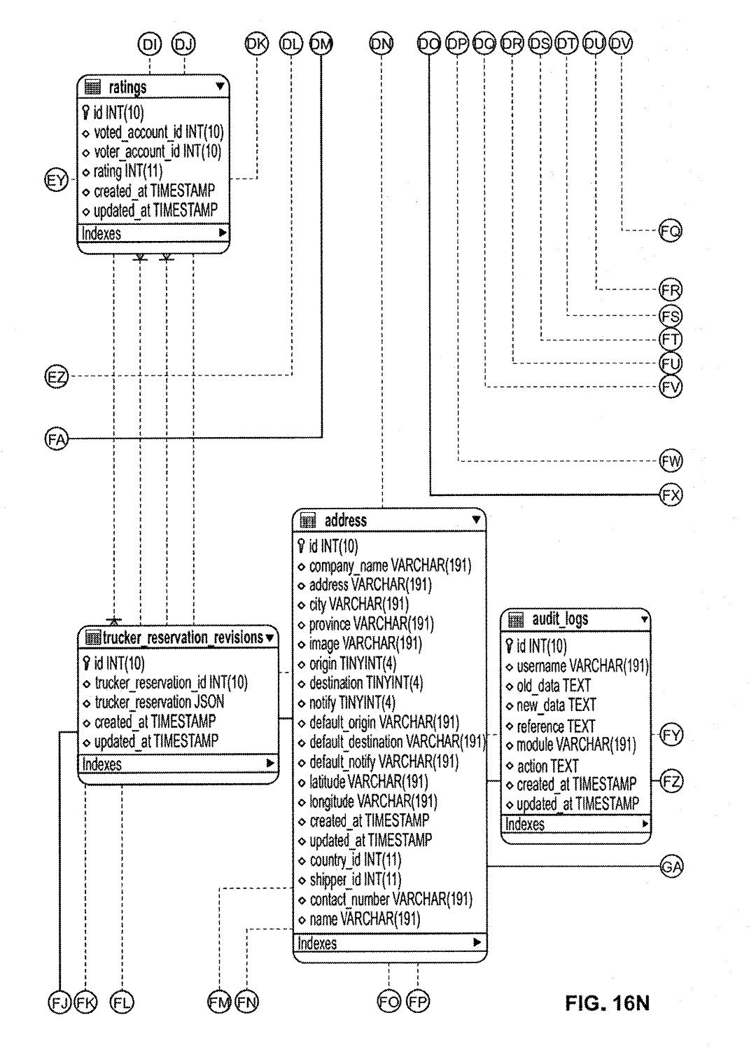

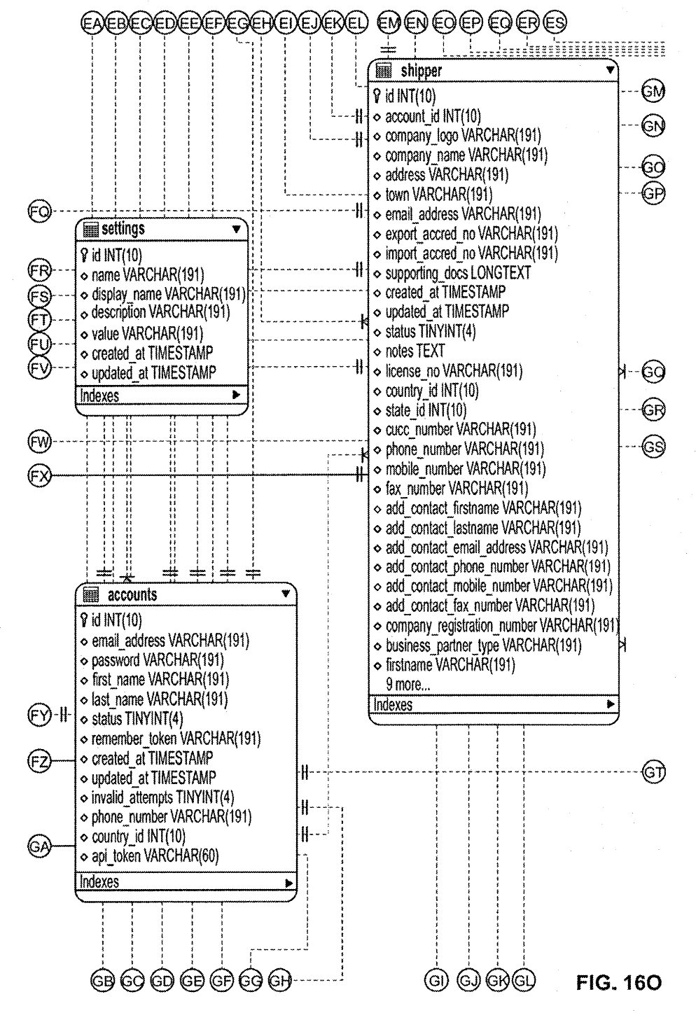

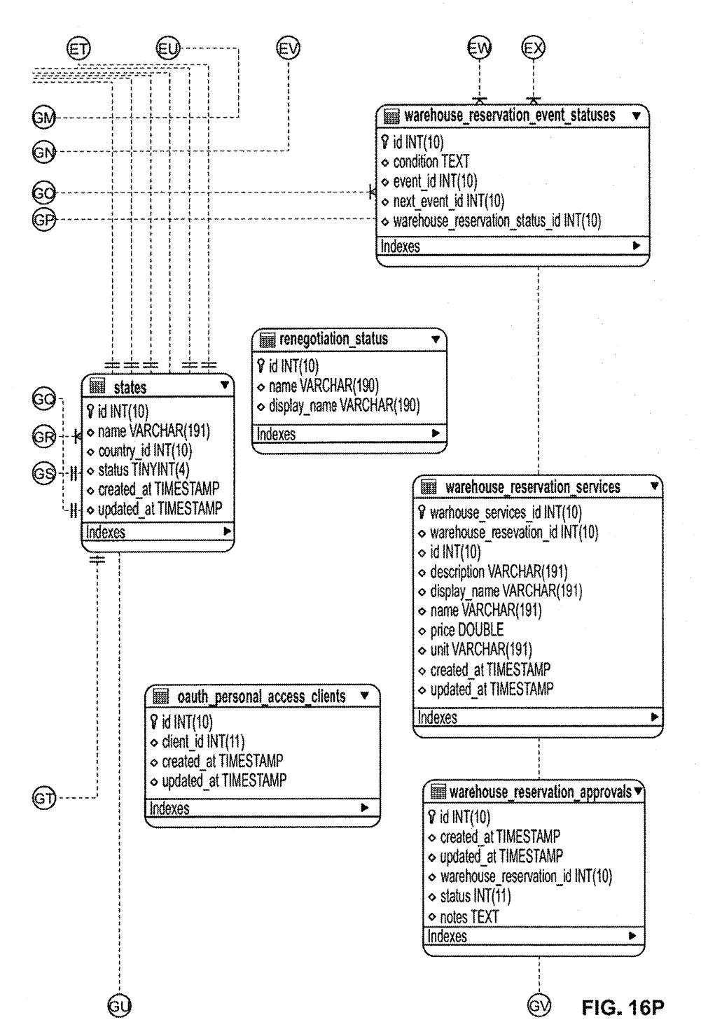

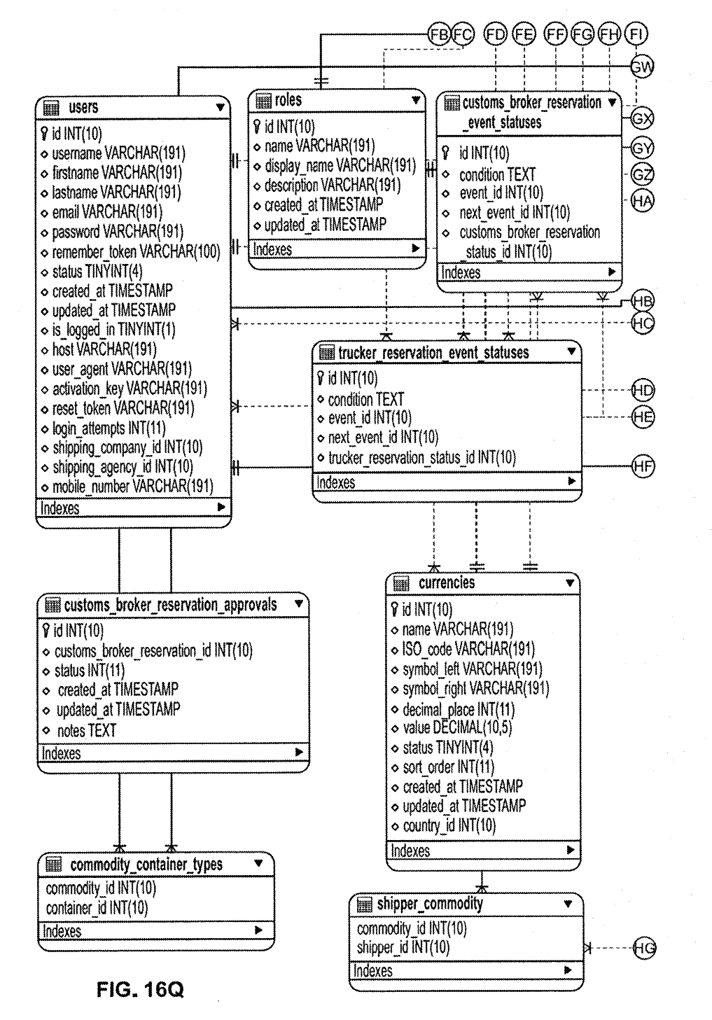

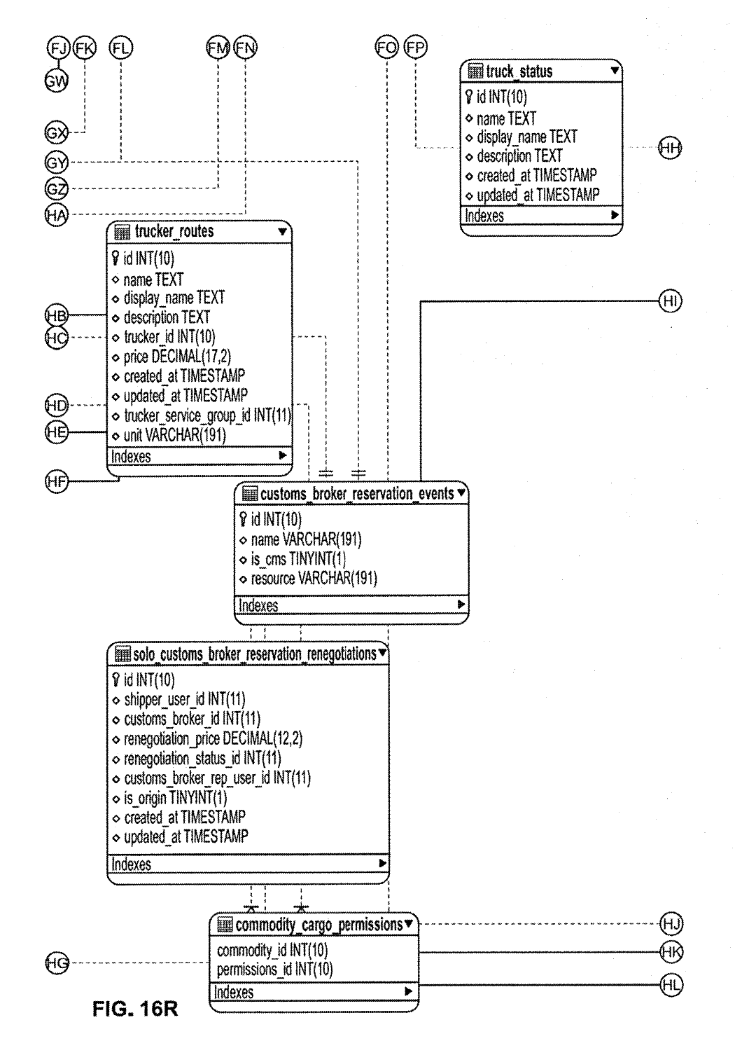

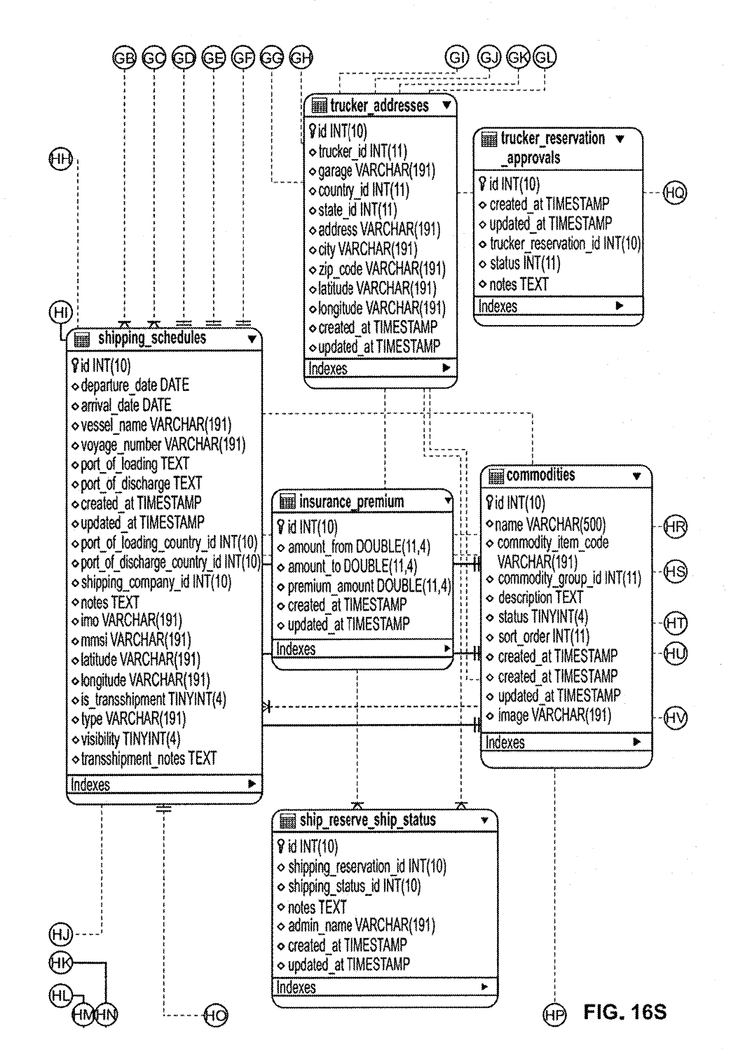

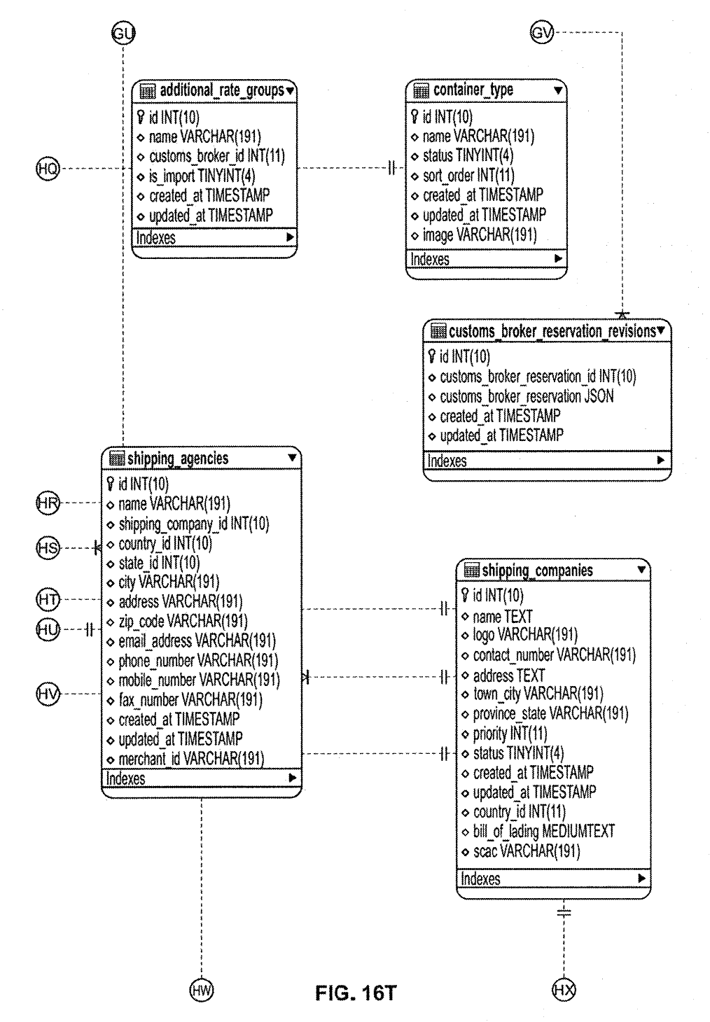

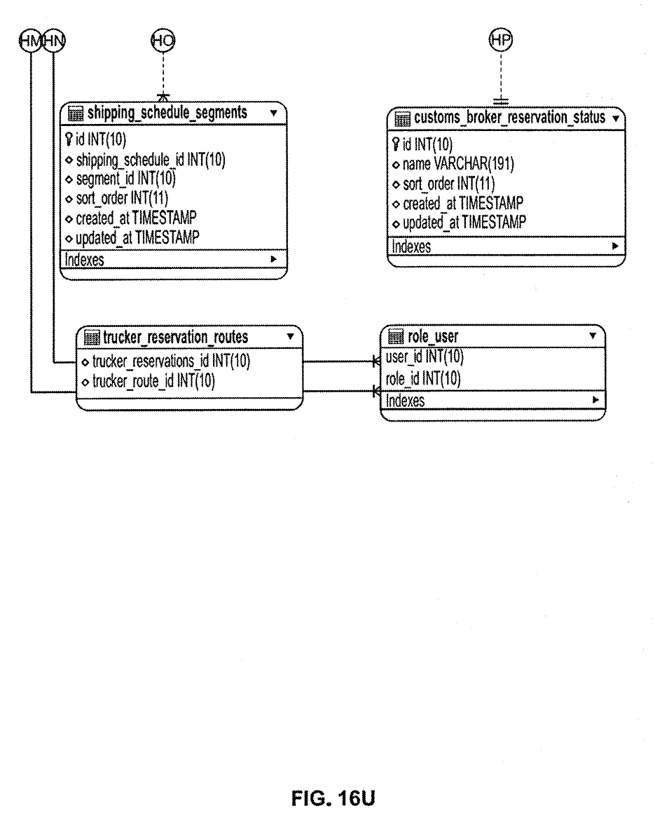

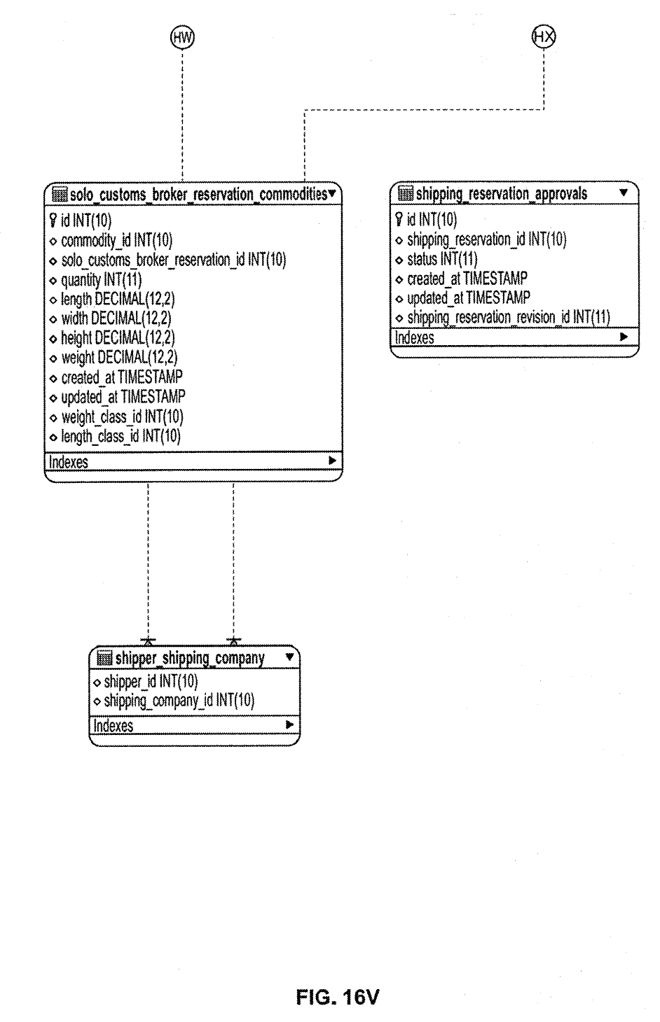

FIGS. 16A-V show the database design in an Entity Relationship Diagram (ERD), according to another example embodiment of the present invention.

The Entity Relationship Diagram illustrates the structure of how the data is stored inside the system 100 of the present invention. The importance of the Entity Relationship Diagram is that the information and data stored inside the computer is organized and stored in an easily retrievable manner. By virtue of this entity relationship, information or data is also not easily corrupted and can be kept secure.

The Entity Relationship Diagram (ERD) is the design of the main storage of information/data of the system 100 of the present invention. The ERD is implemented into a physical database which contains all the information/data about the XLOG system 100 and also contains the information stored inside the black-box. The ERD can be implemented in the black box module.

The ERD is a way of creating a storage for all the data being collected by the system 100. The ERD can be designed in any suitable way.

The ERD reflects a novel and unique idea behind the unique concept of the system of the present invention. The ERD is a back-end implementation of a unique and novel concept.

Categories of entities can be designed to allow the operator to securely store and efficiently retrieve desired data. According to one example embodiment, the categories of entities may include, without limitation: account audit logs, account password history, accounts, additional rate groups, additional rates, address, audit logs, cargo permissions, clients, commodities, commodity cargo permissions, commodity groups, consignee shipper, consignees, container type, countries, currencies, customs broker, customs broker reservation approvals, customs broker reservation event statuses, customs broker reservation events, customs broker reservation revisions, customs broker reservation services, customs broker reservation status, customs broker reservations, forex, image types, images, insurance premium, language lines, languages, length class, migrations, notifications, notify parties, notify party shipper, oauth access tokens, oauth auth codes, oauth personal access clients, oauth refresh tokens, old shipping reservations, password history, password resets, permission role, permissions, personal information, ratings, renegotiation status, reservation status, reservations, role user, roles, settings, ship reserve ship status, ship reserve status, shipper, shipper commodity, shipper customs broker, shipper shipping company, shipper trucker, shipper warehouse, shipping agencies, shipping companies, shipping container reservation, shipping container schedule, shipping containers, shipping reservation approvals, shipping reservation bid requests, shipping reservation event statuses, shipping reservation events, shipping reservation revisions, shipping reservation transshipments, shipping schedule segments, shipping schedules, shipping status, solo customs broker reservation commodities, solo customs broker reservation renegotiations, solo customs broker reservations, solo trucking reservations, solo warehouse reservation commodities, solo warehouse reservation warehouse services, solo warehouse reservations, states, templates, transaction logs, transaction progress, truck status, trucker, trucker addresses, trucker rates, trucker reservation approvals, trucker reservation event statuses, trucker reservation events, trucker reservation revisions, trucker reservation routes, trucker reservation status, trucker reservation trucks, trucker reservations, trucker routes, trucker service groups, trucker trucks, users, warehouse, warehouse reservation approvals, warehouse reservation event statuses, warehouse reservation events, warehouse reservation revisions, warehouse reservation services, warehouse reservation status, warehouse reservations, warehouse service groups, warehouse services, and weight class. Each entity can be configured to include elements that is related to the name of it. Each entity can be linked with at least one other entities so that information or data can be readily retrieved, is not easily corrupted, and can be kept secure. Each entity may have various elements with various data types. An entity can include a primary key (PK) and zero or more foreign keys (FK).

For example, the entity named “trucker” may have: id INTO(10), account_id

INTO(10), company_logo VARCHAR(191), company_name VARCHAR(191), address VARCHAR(191), town VARCHAR(191), email_address VARCHAR(191), licence_no VARCHAR(191), supporting_docs LONGTEXT, created_at TIMESTAMP, updated_at TIMESTAMP, status TINYINT(4), notes TEXT, standard_rate DECIMAL(12,2), country_id INT(10), state_id INT(10), phone_number VARCHAR(191), mobile_number VARCHAR(191), fax_number VARCHAR(191), add_contact_firstname VARCHAR(191), add_contact_lastname VARCHAR(191), add_contact_email_address VARCHAR(191), add_contact_phone_number VARCHAR(191), add_contact_mobile_number_VARCHAR(191), add_contact_fax_number VARCHAR(191), company_registration_number VARCHAR(191), business_partner_type VARCHAR(191), firstname VARCHAR(191), lastname VARCHAR(191), and zip_code VARCHAR(191).The entity named “warehouse_reservations” may have: id INT(10), shipping_reservation_id INT(11), warehouse_id INT(10), final_price DECIMAL(19,2), is_origin INT(11), reservation_start_date DATETIME, reservation_end_date DATETIME, reservation_status_id INT(11), created_at TIMESTAMP, updated_at TIMESTAMP, notes TEXT, total_actual_amount_value DECIMAL(22,4), total_estimated_amount_value DECIMAL(22,4), total_estimated_amount VARCHAR(191), import_total_actual_amount_value DECIMAL(22,4), import_total_estimated_amount_value DECIMAL(22,4), import_total_estimated_amount VARCHAR(191), export_proforma_invoice VARCHAR(191), event_status_id INT(11), is_estimated_amount_paid TINYINT(4), payment_date_estimated_amount DATETIME, payment_date_actual_amount DATETIME, payout_amount DECIMAL(22,4), payout_commission DECIMAL(22,4), payout_paid_at DATETIME, payout_commission_paid_at DATETIME, refunded_at DATETIME, other_remarks TEXT, supporting_documents JSON, and renegotiations JSON.

The entity named “trucker_reservation_approvals” may have: created_at TIMESTAMP, updated_at TIMESTAMP, trucker_reservation_id INT(10), status INT(11), and notes TEXT.

The entity named “ship_reserve_ship_status” may have: shipping_reservation_id INT(10), shipping_status_id INT(10), notes TEXT, admin_name VARCHAR(191), created_at TIMESTAMP, and updated_at TIMESTAMP.

The entity named “shipping_schedules” may have: id INT(10), departure_date DATE, arrival_date DATE, vessel_name VARCHAR(191), voyage_number VARCHAR(191), port_of_loading TEXT, port_of_discharge TEXT, created_at TIMESTAMP, updated_at TIMESTAMP, port_of_loading_country_id INT(10), port_of_discharge_country_id INT(10), shipping_company_id INT(10), notes TEXT, imo VARCHAR(191), mmsi VARCHAR(191), latitude VARCHAR(191), longitude VARCHAR(191), is_transshipment TINYINT(4), type VARCHAR(191), visibility TINYINT(4), and transshipment_notes TEXT.

The entity named “notifications” may have: id INT(10), code VARCHAR(191), subject VARCHAR(191), sender_name VARCHAR(191), sender_email VARCHAR(191), email_content TEXT, sms_content TEXT, signature TEXT, created_at TIMESTAMP, and updated_at TIMESTAMP.

The entity named “transaction_logs” may have: id INT(10), account_id INT(10), role VARCHAR(191), status VARCHAR(191), notes TEXT, customer_name VARCHAR(191), admin_name VARCHAR(191), created_at TIMESTAMP, and updated_at TIMESTAMP.

The entity named “trucker_reservation_events” may have: id INT(10), name VARCHAR(191), is_ems TINYINT(1), and resource VARCHAR(191).

The entity named “customs_broker_reservation_services” may have: customs_broker reservation_id INT(11), additional_rate_id INT(11), created_at TIMESTAMP, updated_at TIMESTAMP, id INT(10), price VARCHAR(191), customs_broker_id INT(11), description VARCHAR(191), and unit VARCHAR(191).

The entity named: “solo_customs_broker_reservation_renegotiations” may have: id INT(10), shipper_user_id INT(11), customs_broker_id INT(11), renegotiation_price DECIMAL(12,2), renegotiation_status_id INT(11), customs_broker_rep_user_id INT(11), is_origin TINYINT(1), created_at TIMESTAMP, and updated_at TIMESTAMP.

The entity named “commodities” may have: id INT(10), name VARCHAR(500), commodity_item_code VARCHAR(191), commodity_group_id INT(11), description TEXT, status TINYINT(4), sort_order INT(11), created_at TIMESTAMP, updated_at TIMESTAMP, and image VARCHAR(191).

The entity named “solo_customs_broker_reservation_commodities” may have: id INT(10), commodity_id INT(10), solo_customs_broker_reservation_id INT(10), quantity INT(11), length DECIMAL(12,2), width DECIMAL(12,2), height DECIMAL(12,2), weight DECIMAL(12,2), created_at TIMESTAMP, updated_at TIMESTAMP, weight_class_id INT(10), and length_class_id INT(10).

The entity named “customs_broker_reservation_revisions” may have: id INT(10), customs_broker_reservation_id INT(10), customs_broker_reservation JSON, created_at TIMESTAMP, and updated_at TIMESTAMP.

The entity named “shipping_reservation_approvals” may have: id INT(10), shipping_reservation_id INT(10), status INT(11), created_at TIMESTAMP, updated_at TIMESTAMP, and shipping_reservation_revision_id INT(11).

The entity named “shipping_reservation_event_statutses” may have: id INT(10), condition TEXT, event_id INT(10), next_event_id INT(10), and shipping_status_id INT(10).

The entity named “additional_rates” may have: additional_price DECIMAL(17,2), customs_broker_id INTO(10), id INT(10), additional_rate_group_id INT(11), unit VARCHAR(191), description VARCHAR(191), is_mandatory TINYINT(4), created_at TIMESTAMP, and updated_at TIMESTAMP.

The entity named “account_audit_logs” may have: id INT(10), account_id INT(10), module VARCHAR(191), action VARCHAR(191), result TINYINT(4), created_at TIMESTAMP, and updated_at TIMESTAMP.

Other data or information can be stored in other entities as shown in FIGS. 5A-T and 16A-V, having a relational database structure.

By storing data this way, the information and data stored inside the database can easily be retrieved, cannot easily be corrupted, and can be kept secure. It is noted that the ERDs shown in FIGS. 5A-T and 16A-V are merely one example of implementing the present disclosure and that other relational database structure can be used to implement the present disclosure.

The present invention according to one aspect is a unique system due to the combined automated and procedural (manual) method of creating a shipping booking (reservation), including the must have service providers, in a way that is much simpler, more efficient, faster, more secure, less expensive, and more convenient manner for main system users such as, e.g., the Shipper (exporter/importer).

Example service providers include, but are not limited to, the Customs Broker, Warehouse owner, Trucking company, and of course the Shipping company. Others are contemplated. The goods being moved around or shipped is the Container in an example embodiment.

The present invention in one aspect is a unique digital platform for the shipping industry. Its end-to-end processing is a much simpler and more effective way of creating a shipping reservation. An end-to-end delivery of goods from the factory of origin to the destinations address—in any country.

Its User Interface is also quite unique. Its database design as reflected in the ERD is also unique. Its combined manual and automated processing is also unique. The needed information collected to achieve a successful shipping reservation is also very unique—others will require around 800 data elements while the present invention in one example aspects only needs around 50 data elements to achieve the same.

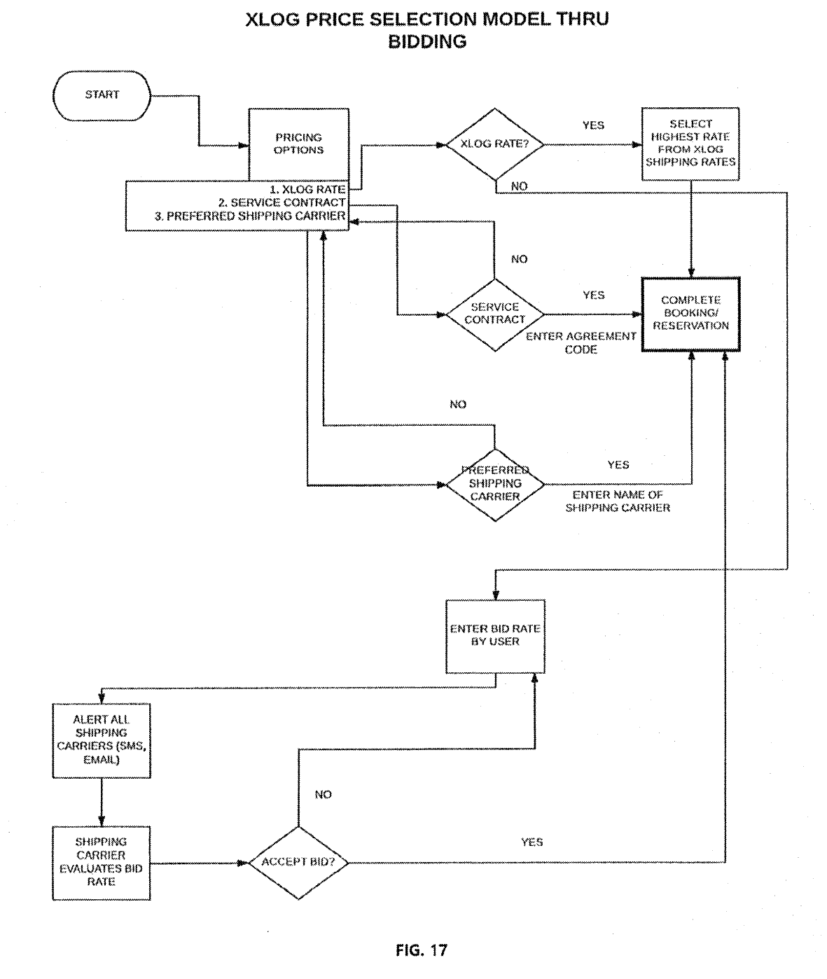

FIG. 17 is a flowchart illustrating a method in which the system of the present invention implements a bidding process (rate) selection for a user given the various rates available from the different shipping carriers, according to an example embodiment of the present invention. FIG. 17 thus illustrates a price selection model of the system through bidding. The method of FIG. 17 can be performed by one of the modules of the present invention such as the middleware module 104 or the end-user module 102 or others.

When a user starts a bidding, the user can choose any one of pricing options including (1) XLOG Rate, (2) Service Contract, and (3) Preferred Shipping Carrier. If the user chooses (1) XLOG Rate, the system determines whether there is a XLOG rate for the bidding. If Yes then the system selects the highest rate from XLOG shipping rates, and the booking/reservation is complete. If No then the user enters a desired bid rate. The system then alerts all shipping carriers through texts or emails. Shipping carriers then evaluate the bid rate. If at least one shipping carriers accepts the bid rate, then the booking/reservation is complete. If no shipping carriers accepts the bid rate, then the user enters a new bid rate.

If the user chooses (2) Service Contract, the system determines if there is a service contract. If Yes then the user enters a name of an agreement code, and the booking/reservation is complete. If No then the queue returns back to “Pricing Options,” where the user can again select any one of options 1-3 as shown in FIG. 17.

If the user chooses (3) Preferred Shipping Carrier, the system determines whether there is a preferred shipping carrier. If Yes then the user enters the name of the shipping carrier, and the booking/reservation is complete. If No then the queue returns back to “Pricing Options.

Technical challenges addressed by the present invention include the following. Stakeholders (e.g., truckers, warehouse operators, brokers, ship owners, etc.) use a combination of manual, legacy, and modern computer systems combined, and this varies per country. Conventionally the practice is to mainly perform the transactions serially or semi-concurrent with a mixture of manual and automated systems. Given this scenario, conventional solutions cannot create an integrated solution that cuts across these various industries to create a fully integrated solution. A unique solution of the present invention addressing this problem is that the present invention in an example embodiment includes a computer software solution which allows it to simultaneously and on a 24/7 mode establish valid and legal agreements with all of the project stakeholders on a verifiable and Internet-based online recording system. This is accomplished through the utilization of various technology and communication platforms which allows no single point of failure in its workflow. The solution of the present invention is a one-stop-shop for exporters and importers of goods across the globe. This is concurrent, real-time, and 24/7 through computer software maintained by a corporation or entity operating the software. In the international industry, these activities are normally done separately for each of the mentioned stakeholders. The present invention revolutionizes how exporting and importing of goods is done by making it significantly simpler and more efficient and fast. Notably, the present invention can dramatically decrease the cost for an exporter and importer.

### Additional Comments about Various Aspects of the Present Invention

The present invention in some aspects discloses an “ELECTRONIC LOGISTICS MAN-AGEMENT SYSTEM BUILT UPON A SPACE-BASED MICROSERVICES ARCHI-TECTURE” comprising: [Element 1] an end-user module which does not interact with any external computer system and which provides a plurality of reservation-related functions; [Element 2] a middleware module which interacts with external computer systems and which processes all transaction requests; [Element 3] a back-office corporate module which does not interact with any external computer system and which ensures integrity of transactions; and [Element 4] wherein one or more components of any of the end-user module, the middleware module, and the back-office corporate modules are dynamically buildable and scalable using space-native microservices.

Accordingly, one aspect of the present invention is an “ELECTRONIC LOGISTICS MANAGEMENT SYSTEM BUILT UPON A SPACE-BASED MICROSERVICES ARCHITECTURE AND HAVING LOGISTIC TRANSACTION RECORDS PUBLISHED INTO A BLOCKCHAIN CONFIGURED DISTRIBUTED ARCHITECTURE-BASED SYSTEM” comprising: [Elements 1, 2, 3, and 4 as defined in one aspect of the invention]; and [Element 5] as defined in another aspect of the invention, wherein the logistics management system has logistic transaction records published into one or more blocks in a blockchain which represents a cryptographically verifiable distributed ledger.

Modules according to one embodiment of the invention include an END-USER MODULE (shipping reservation; truck reservation; warehouse reservation; customs broker reservation; employee collaboration and support); a MIDDLEWARE MODULE (the central processor of all requests for transactions by the various users of the system and interacts with external computer systems); and a BACK-OFFICE CORPORATE MODULE (ensures integrity of all transactions by way of combining automated verifications and procedure-based integrity checks through the user of back-office support staff).

The present invention (1) has applications in a technical field characterized by a computer-implemented and/or computer-based logistics management system suitable for use in the global logistics industry; (2) solves technical problems associated with scalability arising from the need to update software requirements; and (3) has architectural (software components tied up with hardware components and other technology stacks), procedural, and interface designs that comprise the technical features which present technical solutions to technical problems and which result from the exercise of technical skills.

The present invention in one aspect discloses an arrangement of Elements 1, 2, 3 and 4 discussed above that is built upon a space-based microservices architecture. Here, Applicant uses the term “space” in the phrase “space-based microservices architecture” to broadly cover cloud-based computing platforms with physical resources that may reside either on cloud-based hosted services such as PaaS (Platform-as-a-Service), on any preferred local server computing systems, or on combination of both.

The present invention in another aspect discloses an arrangement of Elements 1 to 5 discussed above that is built upon a space-based microservices architecture.

Element 4 characterizes computer-based modules which are dynamically buildable and scalable using space-native microservices. One technical effect of Element 4 is that its logistics management systems' resources can be adjusted to suit updated and/or new business process requirements in the dynamic field of logistics management while incurring minimal cost and consuming significant amount of time. This effectively ameliorates or solves the technical problem of adjusting (e.g., re-evaluation and changes in architecture) of resources to suit up-dated and/or new business process requirements in the dynamic field of logistics management in a cost and time efficient manner. Applicant notes that most business processes nowadays, especially in the dynamic field of logistics management, are agile in character.

The present invention discloses an integrated solution with self-sufficient modules whose re-sources can be adjustably scaled to suit updated and/or new business process requirements in the dynamic field of logistics management in a cost and time efficient manner.

### Industrial Applicability

The present invention have industrial applications as it can be used in the global logistics industry.

### Example Implementation(s)

As noted above, the present invention or any part(s) or function(s) thereof, including but not limited to elements denoted by reference numerals 2, 4, 6, 8, 10, 12, 101, 102, 103, 104, 105, 106, 108, 110, 112, and 114, may be implemented using hardware, software, or a combination thereof, and may be implemented in one or more computer systems or other processing systems and using mobile apps. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The computer system can include a display interface that forwards graphics, text, and other data from the communication infrastructure (or from a frame buffer) for display on a display unit. The display interface can communicate with a browser. The computer system also includes a main memory, preferably a random access memory, and may also include a secondary memory and a database. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. The removable storage unit can represent a floppy disk, magnetic tape, optical disk, etc. which is read by and written to by the removable storage drive. As will be appreciated, the removable storage unit can include a computer usable storage medium having stored therein computer software and/or data.

The computer system may also include a communications interface which allows software and data to be transferred between the computer system and external devices. The terms “computer program medium” and “computer usable medium” are used to refer generally to media such as the removable storage drive, a hard disk installed in the hard disk drive, and signals. These computer program products provide software to the computer system.

Computer programs or control logic are stored in the main memory and/or the secondary memory. Computer programs may also be received via the communications interface. Such computer programs or control logic (software), when executed, causes the computer system or its processor to perform the features and functions of the present invention, as discussed herein.

Accordingly, software embodiments of the present invention may be provided as a computer program product, or software, that may include an article of manufacture on a machine accessible or machine readable medium (memory) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents.

In addition, it should be understood that the Figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

1. A system for processing and storing transactions and reservations for online freight management, comprising:
an end-user module for interfacing with a user device through an exclusive ingress module to execute a login procedure, wherein a user of the user device is a service provider;
a middleware module for processing a request for a transaction by the user;
a back-office corporate module for performing a procedure-based integrity check on each transaction, for managing each transaction, and for interfacing with the user device through an exclusive egress module to execute a logout procedure; and
a black-box module communicating with the middleware module and using blockchain technology for monitoring users and storing data including transaction data, user profile data, and communication data, wherein the black-box module includes an entity relationship database for storing the data in an organized and readily retrievable structure.

2. The system of claim 1, wherein a service provided by the user includes at least one of shipping, trucking, warehouse, online payment, and Enterprise Resource Planning.

3. The system of claim 1, wherein the black-box module has code for permitting users to report and view data and for preventing users from updating, editing, or deleting data recorded therein.

4. The system of claim 1, wherein the end-user module has code for:
accepting a login request from a user device;
determining whether the user who sent the login request has valid login credentials;
authorizing, if it is determined that the user has valid login credentials, access to the user and displaying a dashboard on the user device; and
performing a task as instructed by the user if the user has permission for the task.

5. The system of claim 1, wherein the end-user module has code for:
accepting a logout request from a user;
instructing the middleware module to activate a logout procedure; and
performing a signout procedure.

6. The system of claim 1, wherein the data also comprises at least one of online payment data, login credentials, reservation details, transaction details, audit trails, and logoff credentials.

7. The system of claim 1, wherein functional processes carried out by the end-user module include at least one of shipping reservation, truck reservation, warehouse reservation, custom broker reservation, employee collaboration and support, and processes related to other authorized users.

8. The system of claim 1, wherein the exclusive ingress module comprises a web portal and a database and has code for:
receiving a login request from a user device of a shipper;
checking whether the shipper is authorized to log in;
terminating, if the shipper is not authorized, the login procedure;
enabling, if the shipper is authorized, to log in, and after login:
initiating a work access session;
if the work is importing then obtaining origin and shipment details; and
if the work is exporting then obtaining destination and shipment details.

9. The system of claim 1, wherein the back-office corporate module has code for securely storing all official and confirmed transactions, enabling mining activities leveraging on a database of historical transactions, and storing financial transactions for integration with ERPs and financial applications on an offline/online basis.

10. The system of claim 1, wherein the service provider is at least one of an importer/exporter, a customs broker, a trucking company, a warehouse operator, a shipping company, and a back office systems employee.

11. The system of claim 1, wherein the exclusive ingress module comprises a web portal and a database and includes code for:
sending the user device a password or key via SMS or text message; and
using biometrics for validating the user.

12. The system of claim 1, wherein the exclusive ingress module comprises a web portal and a database and includes code for executing the login procedure for establishing a secure connection between the user device and the end-user module by:
receiving account information entered into a web portal by the user;
determining whether the user is an existing user;
if the user is an existing user, validating account information stored in a database for a further security check before allowing the user access;
if the user is not an existing user:
capturing the account information and saving the account information in a database;
carrying out a main registration protocol and displaying a main registration page on the user device;
receiving registration details entered by the user;
determining whether at least one role is selected;
if at least one role is not selected, returning to the step of carrying out a main registration protocol;
if at least one role is selected, determining whether the registration details entered by the user are valid;
if the registration details entered by the user are valid, saving the registration details in the database; and
if the registration details entered by the user are not valid, returning to the step of carrying out a main registration protocol.

13. The system of claim 1, wherein the middleware module comprises an API interface and further comprises:
an online payment module having code for performing online payment;
a container stuffing module having code for performing container stuffing; and
a shipping company integration module having code for perfoiniing shipping company integration.

14. The system of claim 1, wherein the back-office corporate module comprises:
a data analytics module having code for communicating with the user devices with regard to tasks including at least one of analytics, forecasting, black-box inquiry reports, performance dashboards, and reporting;
a technical support module having code for performing technical support for internal and external users; and
a customer support module having code for carrying out a customer support / ticketing system for reported incidents from internal and external users.

15. The system of claim 1, wherein the exclusive egress module comprises a web portal and a database, and has code for:
receiving a log-off request from the user device through the web portal to log out of a user account;
performing validating of the user account, and if the user account is validated then displaying by the web portal a logoff screen to the user device; and
requesting by the web portal that the user confirm logout, and if a user confirmation of the logout is received then displaying a notification of a successful logout to the user and updating an audit trail database.

16. The system of claim 1, wherein the end-user module includes a sub-module comprising a web portal and a database and having code for:
receiving a login attempt by the user device;
validating login credentials of the user associated with the user device;
upon validation, storing the validated login credentials in the database and displaying a dashboard on the user device by the web portal;
receiving a selection of a shipper account to carry out a shipping or trucking or warehouse reservation and displaying a shipping or trucking or warehouse reservation form on the dashboard;
receiving reservation details entered by the user;
upon validation of the reservation details storing the reservation details in the database; and
generating a bill of lading and notifying the user device of the bill of lading.

17. The system of claim 16, wherein the web portal receives negotiation rates sent by the user device and sends negotiation updates to the user device.

18. The system of claim 1, wherein the black-box module has various levels of software triggers which allow for automatic recording at various levels of the system.

19. A method for processing and storing transactions and reservations for online freight management, comprising:
interfacing with a user device through an exclusive ingress module to execute a login procedure, wherein a user of the user device is a service provider;
processing a request for a transaction by the user;
performing a procedure-based integrity check on each transaction, for managing each transaction, and for interfacing with the user device through an exclusive egress module to execute a logout procedure; and
using blockchain technology for monitoring users and storing data including transaction data, user profile data, and communication data, using an entity relationship database for storing the data in an organized and readily retrievable structure.

20. A non-transitory computer-readable storage medium storing a program which, when executed by at least one processor, causes the at least one processor to perform the method for processing and storing transactions and reservations for online freight management according to claim 19.

21. A method for real-time and online freight management in the global logistics industry, comprising:
(a) providing an end-user module to at least one user among an importer, exporter, customs broker, trucking company, warehouse operator, shipping company, and back-office employee;
(b) by an exclusive ingress module, validating an account based on information stored in a database, saving login data in a cloud storage, and sending an ingress email request to an email service provider, which in turn sends an email confirmation to the at least one user;
(c) by the end-user module, sending to a middleware module at least one of a request to book a ship reservation, a request to book a truck reservation, a request to book a warehouse reservation, a request to secure a broker, and a request to stuff a container with import/export goods;
(d) by the end-user module, making an online payment of the request made in step (c);
(e) by a black box, performing one way recording of all official and confirmed transactions performed in step (d);
(f) by the middleware module, sending a notification of the request made in step (c) to at least one corresponding user among the importer, exporter, customs broker, trucking company, warehouse operator, shipping company, and back-office employee;
(g) by a back-office corporate module, verifying integrity of transactions and storing some of financial transactions for integration with ERPs (Enterprise Resource Planning) and financial applications on an offline and online basis; and
(h) by an exclusive egress module, validating an account based on information stored in a database, saving log-off data in a cloud storage, and sending an egress email request to the email service provider;
wherein
the middleware module is implemented with a web service for third party applications integration infrastructure,
the web service has an Application Program Interface setup that allows secure method for online and real-time integration with various systems, and
the back-office corporate module only interacts with the middleware module and/or the exclusive egress module.

22. A system for real-time and online freight management in the global logistics industry, comprising:
(a) an end-user module, validating an account based on information stored in a database, saving login data in a cloud storage, and sending an ingress email request to an email service provider, which in turn sends an email confirmation to the at least one user, and making an online payment;
(b) an exclusive ingress module, sending to a middleware module a request to book a ship reservation, a truck reservation, and/or a warehouse reservation, a request to secure a broker, and/or a request to stuff a container with import/export goods;
(c) a middleware module, sending a notification of the request made by the end-user module to at least one corresponding user among the importer, exporter, customs broker, trucking company, warehouse operator, shipping company, and back-office employee;
(d) a black box, performing one way recording of all official and confirmed transactions;
(e) a back-office corporate module, verifying integrity of transactions and storing some of financial transactions for integration with ERPs (Enterprise Resource Planning) and financial applications on an offline and online basis; and
(f) an exclusive egress module, validating an account based on information stored in a database, saving log-off data in a cloud storage, and sending an egress email request to the email service provider;
wherein
the middleware module is implemented with a web service for third party applications integration infrastructure,
the web service has an Application Program Interface setup that allows secure method for online and real-time integration with various systems, and
the back-office corporate module only interacts with the middleware module and/or the exclusive egress module.

23. The system for real-time and online freight management in the global logistics industry according to claim 22,
wherein the black-box continuously records all pertinent or relevant transaction in the system, cannot be bypassed, and cannot be updated, edited, or deleted for data recorded in the black-box,
wherein all records stored in the black-box can be reviewed anytime,
wherein data is stored as an entity or a part of the entity of categories, and
wherein the categories comprise: account audit logs, account password history, accounts, additional rate groups, additional rates, address, audit logs, cargo permissions, clients, commodities, commodity cargo permissions, commodity groups, consignee shipper, consignees, container type, countries, currencies, customs broker, customs broker reservation approvals, customs broker reservation event statuses, customs broker reservation events, customs broker reservation revisions, customs broker reservation services, customs broker reservation status, customs broker reservations, forex, image types, images, insurance premium, language lines, languages, length class, migrations, notifications, notify parties, notify party shipper, oauth access tokens, oauth auth codes, oauth personal access clients, oauth refresh tokens, old shipping reservations, password history, password resets, permission role, permissions, personal information, ratings, renegotiation status, reservation status, reservations, role user, roles, settings, ship reserve ship status, ship reserve status, shipper, shipper commodity, shipper customs broker, shipper shipping company, shipper trucker, shipper warehouse, shipping agencies, shipping companies, shipping container reservation, shipping container schedule, shipping containers, shipping reservation approvals, shipping reservation bid requests, shipping reservation event statuses, shipping reservation events, shipping reservation revisions, shipping reservation transshipments, shipping schedule segments, shipping schedules, shipping status, solo customs broker reservation commodities, solo customs broker reservation renegotiations, solo customs broker reservations, solo trucking reservations, solo warehouse reservation commodities, solo warehouse reservation warehouse services, solo warehouse reservations, states, templates, transaction logs, transaction progress, truck status, trucker, trucker addresses, trucker rates, trucker reservation approvals, trucker reservation event statuses, trucker reservation events, trucker reservation revisions, trucker reservation routes, trucker reservation status, trucker reservation trucks, trucker reservations, trucker routes, trucker service groups, trucker trucks, users, warehouse, warehouse reservation approvals, warehouse reservation event statuses, warehouse reservation events, warehouse reservation revisions, warehouse reservation services, warehouse reservation status, warehouse reservations, warehouse service groups, warehouse services, and weight class.

24. The system of claim 1, wherein one or more components of any of the end-user module, the middleware module, and the back-office corporate module are dynamically buildable and scalable using space-native microservices to thereby enable logistics management system resources to be adjustably scaled to suit updated or new business process requirements.
